(19) United States
(12) Patent Application Publication
(10) Pub. No.: US 2014/0190075 A1
(43) Pub. Date: Jul. 10, 2014

(54) Method and Device for Protecting Crop Plants

(71) Applicant: BASF SE, Ludwigshafen (DE)

(72) Inventors: Ulrich Karl, Grunstadt (DE); Hartmut Leininger, Neustadt (DE); Samuel Wells, Cary, NC (US); Jürgen Huff, Ludwigshafen (DE)

(73) Assignee: BASF SE, Ludwigshafen (DE)

(21) Appl. No.: 14/149,222

(22) Filed: Jan. 7, 2014

Related U.S. Application Data
(63) Continuation of application No. 13/875,653, filed on May 2, 2013, now abandoned.
Application No. 13/875,653 is a continuation of application No. 12/513,173, filed on May 1, 2009, now abandoned.
(60) Provisional application No. 60/864,232, filed on Nov. 3, 2006.

(51) Int. Cl. A01G 13/10

(52) U.S. Cl. CPC A01G 13/10
USPC 47/31; 47/32.3

(57) ABSTRACT

A method for protecting crop plants from harmful organisms, which comprises the step of covering one or more of the plants with a device, comprising a stabilizing structure and a meshed fabric, where the meshed fabric is impregnated with a pesticide and is penetrable by light, air and water.

### RELATED APPLICATIONS

The present application is a continuation of U.S. patent application Ser. No. 13/875,653 filed May 2, 2013, which is a continuation of U.S. patent application Ser. No. 12/513,173 filed May 1, 2009, which is a national stage application (under 35 U.S.C. §371) of PCT/EP2007/061376, filed Oct. 24, 2007, which claims benefit of U.S. Provisional application 60/864,232, filed Nov. 3, 2006. The entire contents of each of these applications are hereby incorporated by reference herein in their entirety.

The invention relates to a method for protecting crop plants. The invention further relates to a device for carrying out the method.

Harmful organisms, like insects, acarides or fungi, are a major threat to harvests worldwide and require an extensive use of plant protection agents (pesticides), like insecticides and fungicides

Although the continuous research and development in this field has led to products with considerably reduced toxicity for humans and improved environmental compatibility, there is still the problem that some application methods lead to a certain level of pesticide residues in the plants. This is prohibitive for the use of certain highly effective pesticides. With other pesticides it may delay the possible consumption or processing of fruits and vegetables which could be undesirable with regard to harvesting, storage and sale of the respective products.

Accordingly, there is still a high demand for methods by which crop plants can be protected from harmful organisms that allow the choice of certain effective pesticides without causing considerable residues of pesticides in the plants.

It is known, e.g. from WO 2005/060472 that impregnating mosquito nets with certain insecticides can enhance the efficacy of the net and prevent sleepers from insect stings which could transmit diseases like malaria.

However, such nets are mainly used indoors and although they should show wash fastness, i.e. they should retain their insecticidal activity even after several washings, such nets are not continuously exposed to light, rain and wind.

JP-A 08-163 950 discloses a resin net, produced by compounding a polyolefin resin with a pyrethroid insecticide, for controlling insects parts and, inter alia, agricultural and horticultural uses. According to the disclosure of this document, however, the main intended purpose of this net is to be used “indoors”, e.g. in greenhouses, stables and residences.

WO 03/003827 discloses a fencing structure comprising a substantially upright structure with a height suitable to prevent low flying insects to enter an open air area. The structure is impregnated with an insecticide. Because of the fencing structure it is not necessary that air, water and light can easily penetrate the structure, as the plants are not completely covered by the structure. As a consequence, the rain fastness of the structure can e.g., be improved by making it highly water repellent.

If, however, the whole plant is to be protected by an impregnated netlike structure, several partly contradicting requirements have to be met. Firstly, it is necessary that air, light and water can freely reach the plant in order to ensure its growth and well being, secondly, harmful organisms have to be prevented from entering the structure, and, thirdly, the impregnation of control agents needs to be weather-fast to a certain extent.

It has now been found that all these requirements can be met by protecting the plants with a tent-like device which has been impregnated with certain pesticide binder combinations.

Accordingly, in one aspect of the invention there is provided a method for protecting crop plants from harmful organisms, comprising the step of covering one or more of the plants with a device, comprising a stabilizing structure and a meshed fabric, where the meshed fabric is impregnated with a pesticide and is penetrable by light, air and water.

According to the invention, crop plants can be protected from harmful organisms in an easy and efficient way without health hazard to workers and without causing residues of pesticides in the plants or products resulting therefrom.

In a further aspect of the invention there is provided the use of the said device for protecting crop plants from harmful organisms.

In yet a further aspect of the invention there is provided a device for protecting crop plants from harmful organisms comprising a stabilizing structure and a meshed fabric, where the meshed fabric is impregnated with a pesticide and is penetrable by light, air and water.

The term “crop plants” as used herein means any kind of agricultural crop, including but not limited to cereals, rice, legumes, cotton, tobacco, vegetables and fruit plants.

Preferred are high value crops like vegetables, fruit plants and plants for the beverage, pharmaceutical and tobacco industry and plants from which e.g. natural dyestuffs and natural compounds for applications in cosmetics, cleaning and caring formulations or further chemical and/or biotechnological processing are won.

Vegetable plants or crops include, for example, potatoes, preferably starch potatoes, sweet potatoes and table potatoes; root vegetables, preferably carrots, rutabaga (table beet, stubble turnips, turnips, Brassica rapa. var. rapa f. teltowiensis), scorzoneras, Jerusalem artichoke, root parsley, parsnip, radish and horseradish; tuberous vegetables, preferably kohlrabi, red beet, celeriac, radish; bulbous vegetables, preferably leeks and onions (onion sets and onions for seed production); cabbages, preferably cabbages from the Capitata group (white cabbage, red cabbage, kale, savoy cabbage), cauliflower, Brussels sprouts, broccoli, Brassica oleracea. var. sabellica, stem kale, seakale and Brassica oleracea L. convar. oleracea var. gemmifera DC.; fruiting vegetables, preferably tomatoes (field-grown tomatoes, bush tomatoes, beefsteak tomatoes, greenhouse-grown tomatoes, cocktail tomatoes, processing tomatoes and tomatoes to be sold fresh), melons, egg plants, aubergines, capsicums (bell peppers, paprika, Spanish pepper), chillis, pumpkins, zucchini and cucumbers (field-grown cucumbers, greenhouse-grown cucumbers, snake cucumbers, gherkins); vegetable legumes, preferably dwarf beans (as sword beans, beech beans, flageolet beans, butter beans; dried beans for boiling with green- and yellow-podded varieties), pole beans (as sword beans, beech beans, flageolet beans, butter beans with green-, blue- and yellow-podded varieties), faba beans (field beans, broad beans, varieties with white and black mottled flowers), peas (chickling vetches, chick peas, marrowfat peas, whole-pod peas, sugar peas, peas for shelling, varieties with light-green and dark green immature seeds) and lentils; leaf and stem vegetables, preferably Chinese cabbage, lettuce, cos lettuce, corn salad, iceberg lettuce, romaine lettuce, oak-leaf lettuce, chicory, radicchio, lollo rosso, arugula, endives, spinach, Swiss chard (leaves and stems) and parsley; other vegetables, preferably asparagus, rhubarb, chives, artichokes, mints, sunflowers, Florence fennel, dillweed, garden cress, mustard, poppies, peanuts, sesame and chicories for salad use.

Fruit plants include, for example, fruits from the Rosacea family, like apple, pear, and quince; stone fruits, like apricot, cherry, plum and peach; berries, specifically bramble fruits, like blackberry, raspberry, loganberry and thimbleberry, true berries, like blueberry and cranberry, other berries, like gooseberry and mulberry; accessory fruits, like strawberry; fruits from the Cucurbitacea family, like gourds, including squash and pumpkin; melons and watermelons; citrus and other subtropical fruits, like lemon, lime, grapefruit, mandarine, clementine, tangerine, orange, avocado, guave, kumquat, logan, lychee and passion fruit; dates, figs, grapes, olives and pomegranate; and tropical fruits, like banana, coconut, durian, eggfruit, mango, mangosteen, papaya, pineapple and tamarind.

Plants for the beverage and tobacco industry include tea varieties, coffee and cocoa varieties and tobacco.

Further preferred are ornamental crops, nuts, herbs and spices.

Ornamental crops include (but are not limited to) aster, azalea, begonia, boxwood, cacti, caladium, calla, calendula, carnation, chrysanthemum, coleus, columbine, dahlia, daisy, daylily, delphinium, dianthus, Easter lily, fern, ficus, foxglove, fuchsia, gardenia, geranium, gerbera, gladioli, hibiscus, impatiens, iris, ivy, marigold, nasturtium, pansy, peony, petunia, phlox, pinks, poinsettia, rosemary, rose, rubberplant, salvia, sedum, snapdragon, verbena, vinca, wandering jew and zinnia.

Nuts include almond, Brazil nut, butternut, cashew, chestnut, macadamia, pecan, pistachio and walnut.

Herbs and spices include anise, balm, basil, chamomile, caraway, catnip, celery, chives, coriander, cumin, curry leaf, dandelion, dill, fennel, hyssop, mint, rue, sage, sweet bay, tarragon, thyme, wintergreen and wormwood.

In a preferred embodiment, the crop plants are seedlings of a crop plant, more preferred of a crop plant mentioned above. Also preferably the crop plants are grown in beds or patches and/or form part of a nursery.

The terms “protection” or “protecting” as used herein means a controlling or repelling action.

The term “harmful organism” as used herein means pests, specifically arthropod pests, including insects and arachnids, and harmful micro-organisms, specifically fungi including spores, microbes and viruses.

The term “covering” as used herein means that the fabric or netting forms a physical barrier between the plant to be protected and the harmful organism, but does not imply that the plant is in physical contact with the cover material or that the harmful organism is prevented from reaching the plant.

The meshed fabric is made from a non-rigid material. It is preferably a textile material or plastics material selected from the group consisting of yarn, monofilaments, fibers, like staple fibers and continuous bulk fibers (CBF), fabric, knitgoods, especially netting material, nonwovens, foils, tarpaulins and coating compositions. The netting material may be prepared by any method known in the art, for example by weaving, circular knitting or warp knitting, or by sewing parts of a netting to obtain the desired nettings.

The textile material or plastics material may be made form a variety of natural and synthetic fibers, also as textile blends in woven or non-woven form, as knit goods, yarns or fibers. Natural fibers are for example cotton, wool, silk or bast fibers, like jute, linen, ramie, hemp and kenaf. Synthetic fibers are for example polyamides, polyaramides, polyesters, polyacrylonitriles, polyolefines, for example polypropylene, polyethylene, poly(vinylchloride) or poly(tetrafluoroethylene) (Teflon) and mixtures of fibers, for example mixtures of synthetic and natural fibers. Polyamides, polyolefins and polyesters are preferred. Polyethylene terephthalate is especially preferred.

The term material also includes non-textile substrates such as perforated foils.

Further, the term material includes cellulose-containing materials e.g. cotton materials such as garment or cotton nets.

Preferably, the material is a textile material or plastics material, e.g. polypropylene, polyethylene, polyester or polyamide.

More preferred are nettings made from polyester, especially polyethylene terephthalate. In a further preferred embodiment the material is a cellulose containing material.

The stabilizing structure provides support to the meshed fabric in order for it to cover the plants to be protected. In one embodiment it can be a simple pole which is fixed in the ground and from which the fabric is suspended and preferably fixed to the ground, e.g. by tent pegs in order to form a tent like structure. Several poles can be used as well for the tent like structure.

In a further embodiment the stabilizing structure comprises one or more clamp like structures over which the fabric is suspended.

In yet a further embodiment the stabilizing structure is a framework to which the mesh material is allocated in order to form an enclosed interior in which one or more plants are protected from the harmful organisms.

It is also possible that the stabilizing structure is provided by pots or potting trays or by the plant to be protected itself, e.g. in case of a fruit tree.

The stabilizing structure may be inside or outside of the protective fabric and may be formed by separate structural elements like poles, clamps etc. or in another embodiment form cage-like structures.

Preferably, the material is treated with a composition comprising a pesticide, however, the invention is not limited to such embodiments. E.g., the pesticide can also be incorporated into a fiber during the production of the fiber.

Such materials show good results in controlling the pests and provide long lasting protection to the crop plant.

In a preferred embodiment, the pesticide is incorporated into the material (e.g. into the plastics matrix) or applied to the surface of the material or both.

In a most preferred embodiment, the material is treated with a composition comprising:
a) at least one pesticide (component A), and
b) at least one polymeric binder (component B).

The pesticidal composition comprises in general 0.001 to 95% by weight preferably 0.1 to 45% by weight, more preferably 0.5 to 30% by weight, most preferably 0.5 to 25% by weight, based on the weight of the composition, of at least one pesticide.

The pesticidal composition preferably comprises the following components, based on the solids content of the composition
a) 0.1 to 45% by weight, preferably 0.5 to 30% by weight, more preferably 1 to 25% by weight of at least one pesticide (component A), and
b) 55 to 99% by weight, preferably 70 to 98% by weight, more preferably 75 to 90 by weight of at least one polymeric binder (component B),
   wherein the sum of the components is 100% by weight of solids content of the pesticidal composition.

In a further preferred embodiment the pesticidal composition comprises the following components, based on the solids content of the composition,
a) 20 to 70% by weight, preferably 25 to 65% by weight, more preferably 30 to 65% by weight of at least one pesticide (component A), and
b) 30 to 80% by weight, preferably 35 to 75% by weight, more preferably 35 to 70 by weight of at least one polymeric binder (component B),
   wherein the sum of the components is 100% by weight of solids content of the pesticidal composition.

The term “pesticide” as used herein comprises insecticides, repellents, fungicides, molluscicides and rodenticides.

The term “insecticides” as used herein comprises agents with arthropodicidal (specifically insecticidal, acaricidal and miticidal) activity, if not otherwise stated in the context.

The term “fungicides” as used herein comprises agents with fungicidal, microbicidal and viricidal activity, if not otherwise stated in the context.

Preferably, the pesticide is an insecticide or a repellent.

The pesticidal composition is particularly suitable for application to polyester nettings as used according to the invention.

The pesticidal composition of the present invention may be applied to textile materials or plastics material, before their formation into the desired products, i.e. while still a yarn or in sheet form, or after formation of the desired products.

### Pesticide (Component A)

Preferably, the pesticide is an insecticide and/or repellent with a fast paralyzing or killing effect of the insect and low mammalian toxicity. Suitable insecticides and/or repellents are known by a person skilled in the art. Suitable insecticides and repellents are disclosed e.g. in E. C. Tomlin et al., The Pesticide Manual, 14ed., The British Crop Protection Council, Farnham 2006, and the literature cited therein.

Preferred insecticides and/or repellents are mentioned below:

Pyrethroid compounds such as
Etofenprox: 2-(4-ethoxyphenyl)-2-methylpropyl-3-phenoxybenzyl ether,
Fenvalerate: (RS)-alpha-cyano-3-phenoxybenzyl (RS)-2-(4-chlorophenyl)-3 methylbutyrate,
Esfenvalerate: (S)-alpha-cyano-3-phenoxybenzyl (S)-2-(4-chlorophenyl)-3-methylbutyrate,
Fenpropathrin: (RS)-alpha-cyano-3-phenoxybenzyl 2,2,3,3-tetramethylcyclopropanecarboxylate,
Cypermethrin: (RS)-alpha-cyano-3-phenoxybenzyl (1RS)-cis, trans-3-(2,2-dichlorovinyl)-2,2-dimethylcyclopropanecarboxylate,
alpha-Cypermethrin: racemate comprising the (S)- -(1R) and (R)- -(1S) diastereomers, preferably with a particle size of from 500 nm to 6 μm,
zeta-Cynermethrin,
Permethrin: 3-phenoxybenzyl (1RS)-cis, trans-3-(2,2-dichlorovinyl)-2,2-dimethylcyclopropanecarboxylate,
Cyhalothrin: (RS)-alpha-cyano-3-phenoxybenzyl (Z)-(1RS)-cis-3-(2-chloro-3,3,3-trifluoroprop-1-enyl)-2,2-dimethylcyclopro panecarboxylate, lambda-cyhalothrin,
lambda-Cyhalothrine: -cyano-3-phenoxybenzyl-3-(2-chloro-3,3,3-trifluoroprop-1-enyl)-2,2-dimethylcyclopropane carboxylate, as a 1:1 mixture of (Z)-(1R,3R), R-ester and (Z)-(1S,3S), S-ester,
Deltamethrin: (S)-alpha-cyano-3-phenoxybenzyl (1R)-cis-3-(2,2-dibromovinyl)-2,2-dimethylcyclopropanecarboxylate,
Cycloprothrin: (RS)-alpha-cyano-3-phenoxybenzyl (RS)-2,2-dichloro-1-(4-ethoxyphenyl)cyclopropanecarboxylate,
Fluvalinate: alpha-cyano-3-phenoxybenzyl N-(2-chloro-alpha, alpha, alpha, alpha-trifluoro-p-tolyl)-D-valinate,
Bifenthrin: (2-methylbiphenyl-3-ylmethyl)0(Z)-(1RS)-cis-3-(2-chloro-3,3,3-trifluoro-1-propenyl)-2,2-dimethylcyclopropanecarboxylate,
2-methyl-2-(4-bromodifluoromethoxyphenyl)propyl (3-phenoxybenzyl)ether,
Tralomethrin: (S)-alpha-cyano-3-phenoxybenzyl (1R-cis)3((1′RS)(1′,2′,2′,2′-tetrabromoethyl))-2,2-dimethylcyclopropanecarboxylate,
Silafluofen: 4-ethoxyphenyl(3-(4-fluoro-3-phenoxyphenyl)propyl}dimethylsilane,
D-Fenothrin: 3-phenoxybenzyl (1R)-cis, trans)-chrysanthemate,
Cyphenothrin: (RS)-alpha-cyano-3-phenoxybenzyl (1R-cis, trans)-chrysanthemate, D-resmethrin: 5-benzyl-3-furylmethyl (1R-cis, trans)-chrysanthemate,
Acrinathrin: (S)-alpha-cyano-3-phenoxybenzyl (1R-cis(Z))-(2,2-dimethyl-3-(oxo-3-(1,1,1,3,3,3-hexafluoropropyloxy)propenyl(cyclopropanecarboxylate,
Cyfluthrin: (RS)-alpha-cyano-4-fluoro-3-phenoxybenzyl 3-(2,2-dichlorovinyl)-2,2-dimethylcyclopropanecarboxylate,
Tefluthrin: 2,3,5,6-tetrafluoro-4-methylbenzyl (1RS-cis (Z))-3-(2-chloro-3,3,3-trifluoro-prop-1-enyl)-2,2-dimethylcyclopropanecarboxylate,
Transfluthrin: 2,3,5,6-tetrafluorobenzyl (1R-trans)-3-(2,2-dichlorovinyl)-2,2-dimethylcyclopropanecarboxylate,
Tetramethrin: 3,4,5,6-tetrahydrophthalimidomethyl (1RS)-cis, trans-chrysanthemate,
Allethrin: (RS)-3-allyl-2-methyl-4-oxocyclopent-2-enyl (1RS)-cis, trans-chrysanthemate,
Prallethrin: (S)-2-methyl-4-oxo-3-(2-propynyl)cyclopent-2-enyl (1R)-cis, trans-chrysanthemate,
Empenthrin: (RS)-1-ethynyl-2-methyl-2-pentenyl (1R)-cis,trans-chrysanthemate,
Imiprothrin: 2,5-dioxo-3-(prop-2-ynyl)imidazolidin-1-ylmethyl (1R)-cis, trans-2,2-dimethyl-3-(2-methyl-1-propenyl)-cyclopropanecarboxylate,
D-Flamethrin: 5-(2-propynyl)-furfuryl (1R)-cis, trans-chrysanthemate, and 5-(2-propynyl)furfuryl 2,2,3,3-tetramethylcyclopropanecarboxylate,
Pyriproxyfen: 4-phenoxyphenyl (RS)-2-(2-pyridyloxy)propyl ether,
Pyrethrum,
d-d, trans-Cyphenothrin: (RS)-α-cyano-3-phenoxybenzyl (1RS,3RS;1RS,3SR)-2,2-dimethyl-3-(2-methylprop-1-enyl)cyclopropanecarboxylate,
DDT,
Cyfluthrin;
   Carbamate compounds such as
Alanycarb: S-methyl-N[[N-methyl-N[N-benzyl-N(2-ethoxy-carbonylethyl)amino-thio]carbamoyl]thioacetimidate,
Bendiocarb: 2,2-dimethyl-1,3-benzodioxol-4-yl-methylcarbamate),
Carbaryl: 1-naphthyl N-methylcarbamate,
Isoprocarb: 2-(1-methylethyl)phenyl methylcarbamate,
Carbosulfan: 2,3 dihydro-2,2-dimethyl-7-benzofuranyl[(dibutylamino)thio]methylcarbamate,
Fenoxycarb: ethyl[2-(4-phenoxyphenoxy)ethyl]carbamate,
Indoxacarb: Methyl-7-chloro-22,3,4°,5-tetrahydro-2-[methoxycarbonyl (-4-trifluoromethoxyphenyl)],
Propoxur: 2-isopropyloxyphenol methylcarbamate,
Pirimicarb: 2-dimethylamino-5,6-dimethyl-4-pyrimidinyl-dimethylcarbamate,
Thiodiocarb: dimethyl N,N′(thiobis((methylimino)carbonoyloxy)bisethanimidiothioate).
Methomyl: S-methyl N-((methylcarbamoyl)oxy)thioacetamidate,
Ethiofencarb: 2-((ethylthio)methyl)phenyl methylcarbamate,
Fenothiocarb: S-(4-phenoxybutyl)-N,N-dimethyl thiocarbamate,
Cartap: S,S′-(2-5 dimethylamino)trimethylene)bis (thiocarbamate)hydrochloride,
Fenobucarb: 2-sec-butylphenylmethyl carbamate,
XMC: 3,5-dimethylphenyl-methyl carbamate,
Xylylcarb: 3,4-dimethylphenylmethylcarbamate;
aldicarb, benfuracarb, carbofuran, carbosulfan, methiocarb, fenobucarb, oxamyl, methomyl, thiodicarb, and triazamate;
   organophosphorous compounds such as
Trichlorfon: Phosphoric acid, (2,2,2-trichloro-1-hydroxyethyl)-dimethyl ester
Fenitrothion: O,O-dimethyl O-(4-nitro-m-tolyl)phosphorothioate,
Diazinon: O,O-diethyl-O-(2-isopropyl-6-methyl-4-pyrimidinyl)phosphorothioate,
Pyridaphenthion: O-(1,6-dihydro-6-oxo-1-phenylpyrazidin-3-yl) O,O-diethyl phosphorothioate,
Pirimiphos-Etyl: O,O-diethyl O-(2-(diethylamino)6-methyl-pyrimidinyl)phosphorothioate,
Pirimiphos-Methyl: O-[2-(diethylamino)-6-methyl-4 pyrimidinyl] O,O-dimethyl phosphorothioate,
Etrimphos: O-6-ethoxy-2-ethyl-pyrimidin-4-yl-O,O-dimethyl-phosphorothioate,
Fenthion: O,O-dimethyl-O-[-3-methyl-4-(methylthio)phenyl phosphorothioate,
Phoxim: 2-(diethoxyphosphinothoyloxyimino)-2-phenylacetonitrile,
Chlorpyrifos: O,O-diethyl-O-(3,5,6-trichloro-2-pyrinyl)phosphorothioate,
Chlorpyriphos-methyl: O,O-dimethyl O-(3,5,6-trichloro-2-pyridinyl)phosphorothioate,
Cyanophos: O,O-dimethyl O-(4 cyanophenyl)phosphorothioate,
Pyraclofos: (R,S)[4-chlorophenyl)-pyrazol-4-yl]-O-ethyl-S-n-propyl phosphorothioate,
Acephate: O, S-dimethyl acetylphosphoroamidothioate,
Azamethiphos: S-(6-chloro-2,3-dihydro-oxo-1,3-oxazolo[4,5-b]pyridine-3-ylmethyl phosphorothioate,
Malathion: O,O-dimethyl phosphorodithioate ester of diethyl mercaptosuccinate,
Temephos: (O,O′(thiodi-4-1-phenylene) O,O,O,O-tetramethyl phosphorodithioate,
Dimethoate: ((O,O-dimethyl S-(n-methylcarbamoylethyl)phosphorodithioate,
Formothion: S[2-formylmethylamino]-2-oxoethyl]-O,O-dimethyl phosphorodithioate,
Phenthoate: O,O-dimethyl S-(alpha-ethoxycarbonylbenzal)-phosphorodithioate,
Iodofenphos: O-(2,5-dichloro-4-iodophenyl)-O,O-dimethyl-phosphorthioate,
Monocrotophos, methamidophos, parathion-methyl, profenfos, and terbufos;
   Insecticides with a sterilising effect on adult mosquitoes such as
1-(alpha-(chloro-alpha-cyclopropylbenzylidenamino-oxy)-p-tolyl)-3-(2,6-difluorobenzoyl)urea,
Diflubenzuron: N-(((3,5-dichloro-4-(1,1,2,2-tetraflouroethoxy)phenylamino)carbonyl)2,6 difluoro benzamid,
Triflumuron: 2-Chloro-N-(((4-(trifluoromethoxy)phenyl)-amino-)carbonyl)benzamide, or a triazin such as N-cyclopropyl-1,3,5-triazine-2,4,6-triamin;
Nicotinic acetylcholine receptor agonists such as: acetamiprid, clothianidin, dinotefuran, imidacloprid, nitenpyram, thiacloprid, thiamethoxam, nicotine, bensultap, thiocyclam, spinosyns;
Chlorine channel activators such as: abamectin, emamectin benzoate, milbemectin;
Juvenile hormone mimics such as: hydroprene, kinoprene, methoprene, fenoxycarb, pyriproxyfen;
Selective feeding blockers such as: cryolite, pymetrozine, flonicamid;
Mite growth inhibitors such as: clofentezine, hexythiazox, etoxazole;
Microbial insecticides such as: Bacillus thuringiensis, B. t. aizawai, B. t. kurstaki, B. t. tenebrionis, B. sphaericus;
Inhibitors of oxidative phosphorylation, disruptors of ATP formation such as: diafenthiuron, azocyclotin, cyhexatin, fenbutatin oxide, propargite, tetradifon;
Uncouplers of oxidative phosphorylation such as: chlorfenapyr, DNOC (4,6-dinitro-o-cresol);
Inhibitors of chitin biosynthesis such as: chlorfluazuron, fluazuron, diflubenzuron, flufenoxuron, hexaflumuron, novaluron, noviflumuron, teflubenzuron, triflumuron, buprofezin;
Ecdysone agonists and molting disruptors such as: cyromazine, azadirachtin, chromafenozide, halofenozide, methoxyfenozide, tebufenazide;
Octopamineergic agonists such as: amitraz;
Coupling site II electron transport inhibitors such as: hydramethylnon, acequinocyl, fluacrypyrim;
Coupling site I electron transport inhibitors such as: fenazaquin, fenpyroximate, pyrimidifen, pyridaben, tebufenpyrad, tolfenpyrad, rotenone;
Voltage dependent sodium channel blockers such as: indoxacarb;
Inhibitors of lipid synthesis such as: spirodiclofen, spiromesifen;
Mitochondrial complex IV electron transport inhibitors such as: phosphides, cyanide, phosphine;
Neuronal inhibitors such as: bifenazate;
Aconitase inhibitors such as: fluoroacetyate;
Synergists such as: pieronyl butoxide, DEF ((BuS)₂P(CO)SBu);
Ryanodine receptor modulator such as: flubendiamide;
Compounds with unknown mode of action such as: benzoximate, chinomethionat, dicofol, pyridalyl;
Miscellaneous non specific inhibitors such as: borax, tartar emetic.

Suitable repellents are preferably selected from N,N-Diethyl-meta-toluamide (DEET), N,N-diethylphenylacetamide (DEPA), 1-(3-cyclohexan-1-yl-carbonyl)-2-methylpiperine, (2-hydroxymethylcyclohexyl) acetic acid lactone, 2-ethyl-1,3-hexandiol, indalone, methylneodecanamide (MNDA), a pyrethroid not used for insect control such as {(+/−)-3-allyl-2-methyl-4-oxocyclopent-2-(+)-enyl-(+)-trans-chrysantemate (Esbiothrin), a repellent derived from or identical with plant extracts like limonene, eugenol, (+)-eucamalol (1), (−)-1-epi-eucamalol or crude plant extracts from plants like Eucalyptus maculata, Vitex rotundifolia, Cymbopogan martinii, Cymbopogan citratus (lemon grass), Cymopogan nartdus (citronella), IR3535 (ethyl butylacetylaminopropionate), icaridin (1-piperidinecarboxylic acid 2-(2-hydroxyethyl)-1-methylpropylester).

A suitable molluscicide is for example niclosamide.

Suitable fungicides are for example
Azoles such as Bitertanol, Bromoconazole, Cyproconazole, Difenoconazole, Dinitroconazole, Epoxiconazole, Fenbuconazole, Fluquiconazole, Flusilazole, Flutriafol, Hexaconazole, Imazalil, Ipconazole, Metconazole, Myclobutanil, Penconazole, Propiconazole, Prochloraz, Prothioconazole, Simeconazole, Tebuconazole Tetraconazol, Triadimefon, Triadimenol, Triflumizol, Triticonazol;
Strobilurines such as Azoxystrobin, Dimoxystrobin, Fluoxastrobin, Kresoxim-methyl, Metominostrobin Orysastrobin, Picoxystrobin, Pyraclostrobin and Trifloxystrobin;
Acylalanines such as Benalaxyl, Metalaxyl, Mefenoxam, Ofurace, Oxadixyl;
Aminderivatives such as Aldimorph, Dodine, Dodemorph, Fenpropimorph, Fenpropidin, Guazatine, Iminoctadine, Spiroxamin, Tridemorph;
Anilinopyrimidines such as Pyrimethanil, Mepanipyrim, Cyprodinil;
Dicarboximide such as Iprodion, Myclozolin, Procymidon, Vinclozolin;
Cinnamic amides and derivatives such as Dimethomorph, Flumetover, Flumorph;
Antibiotics as Cycloheximide, Griseofulvin, Kasugamycin, Natamycin, Polyoxin, Streptomycine;
Dithiocarbamates such as Ferbam, Nabam, Maneb, Mancozeb, Metam, Metiram, Propineb, Polycarbamat, Thiram, Ziram Zineb;
Heterocyclic compounds such as Anilazin, Benomyl, Boscalid, Carbendazim, Carboxin, Oxycarboxin, Cyazofamid, Dazomet, Dithianon, Famoxadon, Fenamidon, Fenarimol, Fuberidazol, Flutolanil, Furametpyr, Isoprothiolan, Mepronil, Nuarimol, Picobenzamid, Probenazol, Proquinazid, Pyrifenox, Pyroquilon, Quinoxyfen, Silthiofam, Thiabendazol, Thifluzamid, Thiophanat-methyl, Tiadinil, Tricyclazol, Triforine M;
Nitrophenylderivatives such as Binapacryl, Dinocap, Dinobuton, Nitrophthal-isopropyl; Phenylpyrroles such as Fenpiclonil, Fludioxonil;
Ianorganic compounds such as Bordeaux mixture, coppper acetate, copper hydroxide, copper octanoate, copper oxychloride, copper sulfate, copper sulfate (tribasic), sulfur;
Derivatives of sulfenic acid such as Captafol, Captan, Dichlofluanid, Folpet, Tolylfluanid;
Other fungicides such as Acibenzolar-S-methyl, Benthiavalicarb, arpropamid, Chlorothalonil, Cyflufenamid, Cymoxanil, Dazomet, Diclomezin, Diclocymet, Diclofluanid, Diethofencarb, Edifenphos, Ethaboxam, Fenhexamid, Fentin-Acetat, Fenoxanil, Ferimzone, Fluazinam, Fosetyl, Fosetyl-Aluminium, Phosphoric Acid, Iprovalicarb, Hexachlorbenzene, Metrafenon, Pencycuron, Propamocarb, Phthalid, Toloclofos-Methyl, Quintozene, Zoxamid.

In a further preferred embodiment, the pesticide is at least one N-arylhydrazine derivative, preferably of formula I,

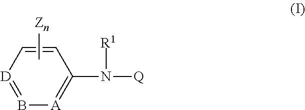

wherein
A is C—R² or N;
B is C—R³ or N;
D is C—R⁴ or N;
with the proviso that at least one of A, B or D must be other than N;
Z is halogen, CN, NO₂, C₁-C₆-alkyl, C₁-C₆-haloalkyl, C₁-C₆-alkoxy or C₁-C₆-haloalkoxy;
n is an integer of 0, 1 or 2;
Q is

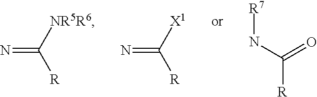

wherein
R is hydrogen;
C₁-C₁₀-alkyl, optionally substituted with one or more halogens; C₃-C₆-cycloalkyl; C₁-C₄-alkoxy; C₁-C₄-haloalkoxy; (C₁-C₄-alkyl)SOₓ; (C₁-C₄-haloalkyl)SOₓ; phenyl, optionally substituted with one to three halogen, C₁-C₄-alkyl, C₁-C₄-haloalkyl, C₁-C₄-alkoxy, C₁-C₄-haloalkoxy, (C₁-C₄-alkyl)SOₓ, (C₁-C₄-haloalkyl)SOₓ, NO₂ or CN groups; phenoxy, optionally substituted with one to three halogen, C₁-C₄-alkyl, C₁-C₄-haloalkyl, C₁-C₄-alkoxy, C₁-C₄-haloalkoxy, (C₁-C₄-alkyl)SOₓ, (C₁-C₄-haloalkyl)SOₓ, NO₂ or CN groups; C₃-C₁₂-cycloalkyl, optionally substituted with one or more halogens, C₁-C₆-alkyl, C₁-C₆-haloalkyl, C₁-C₄-alkoxy, C₁-C₄-haloalkoxy, (C₁-C₄-alkyl)SOₓ, (C₁-C₄-haloalkyl)SOₓ; phenyl, optionally substituted with one to three halogen, C₁-C₄-alkyl, C₁-C₄-haloalkyl, C₁-C₄-alkoxy, C₁-C₄-haloalkoxy, NO₂ or CN groups; phenoxy, optionally substituted with one to three halogen, C₁-C₄-alkyl, C₁-C₄-haloalkyl, C₁-C₄-alkoxy, C₁-C₄-haloalkoxy, NO₂ or CN groups; or
phenyl, optionally substituted with one or more halogens, C₁-C₄-alkyl, C₁-C₄-haloalkyl, C₁-C₄-alkoxy, C₁-C₄-haloalkoxy, NO₂ or CN groups; or
CR¹⁷R¹⁸R¹⁹;
R¹⁷ and R¹⁸ are each independently C₁-C₆-alkyl, C₃-C₆-alkenyl, C₃-C₆-alkynyl, or C₃-C₆-cycloalkyl which may be substituted with 1 to 3 halogen atoms;
R¹⁹ is hydrogen or C₁-C₆-alkyl;
R¹ and R⁷ are each independently hydrogen or C₁-C₄-alkyl;
R⁵ and R⁶ are each independently hydrogen;
C₁-C₁₀-alkyl, optionally substituted with one or more halogen, hydroxy, C₁-C₄-alkoxy, (C₁-C₄-alkyl)SOₓ, CONR⁸R⁹, CO₂R¹⁰, R¹¹, R¹²;
C₃-C₆-cycloalkyl, optionally substituted with one to three halogen, C₁-C₄-alkyl, C₁-C₄-haloalkyl, C₁-C₄-alkoxy, C₁-C₄-haloalkoxy, NO₂ or CN groups;
   phenyl, optionally substituted with one or more halogen, C₁-C₄-alkyl, C₁-C₄-haloalkyl, C₁-C₄-alkoxy, C₁-C₄-haloalkoxy, NO₂ or CN groups;
   pyridyl, optionally substituted with one or more halogen, C₁-C₄-alkyl, C₁-C₄-haloalkyl, C₁-C₄-alkoxy, C₁-C₄-haloalkoxy, NO₂ or CN groups;
   C₃-C₁₀-alkenyl, optionally substituted with one or more halogen, hydroxy, C₁-C₄-alkoxy, (C₁-C₄-alkyl)SOₓ, CONR⁸R⁹, CO₂R¹⁰, R¹¹, R¹²;
   C₃-C₆-cycloalkyl, optionally substituted with one to three halogen, C₁-C₄-alkyl, C₁-C₄-haloalkyl, C₁-C₄-alkoxy, C₁-C₄-haloalkoxy, NO₂ or CN groups;
   phenyl, optionally substituted with one or more halogen, C₁-C₄-alkyl, C₁-C₄-haloalkyl, C₁-C₄-alkoxy, C₁-C₄-haloalkoxy, NO₂ or CN groups;
   pyridyl, optionally substituted with one or more halogen, C₁-C₄-alkyl, C₁-C₄-haloalkyl, C₁-C₄-alkoxy, C₁-C₄-haloalkoxy, NO₂ or CN groups;
   C₃-C₁₀-alkynyl, optionally substituted with one or more halogen, hydroxy, C₁-C₄-alkoxy, (C₁-C₄-alkyl)SOₓ, CONR⁸R⁹, CO₂R¹⁰, R¹¹, R¹²;
   C₃-C₆-cycloalkyl, optionally substituted with one to three halogen, C₁-C₄-alkyl, C₁-C₄-haloalkyl, C₁-C₄-alkoxy, C₁-C₄-haloalkoxy, NO₂ or CN groups;
   phenyl, optionally substituted with one or more halogen, C₁-C₄-alkyl, C₁-C₄-haloalkyl, C₁-C₄-alkoxy, C₁-C₄-haloalkoxy, NO₂ or CN groups;
   pyridyl, optionally substituted with one or more halogen, C₁-C₄-alkyl, C₁-C₄-haloalkyl, C₁-C₄-alkoxy, C₁-C₄-haloalkoxy, NO₂ or CN groups;
   C₃-C₁₂-cycloalkyl, optionally substituted with one or more halogen, hydroxy, C₁-C₄-alkoxy, (C₁-C₄-alkyl)SOₓ, CONR⁸R⁹, CO₂R¹⁰, R¹¹, R¹²;
   C₃-C₆-cycloalkyl, optionally substituted with one to three halogen, C₁-C₄-alkyl, C₁-C₄-haloalkyl, C₁-C₄-alkoxy, C₁-C₄-haloalkoxy, NO₂ or CN groups;
   phenyl, optionally substituted with one or more halogen, C₁-C₄-alkyl, C₁-C₄-haloalkyl, C₁-C₄-alkoxy, C₁-C₄-haloalkoxy, NO₂ or CN groups;
   pyridyl, optionally substituted with one or more halogen, C₁-C₄-alkyl, C₁-C₄-haloalkyl, C₁-C₄-alkoxy, C₁-C₄-haloalkoxy, NO₂ or CN groups;
   R⁵ and R⁶ may be taken together to form a ring represented by the structure

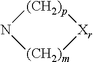

R², R³ and R⁴ are each independently hydrogen, halogen, CN, NO₂, (C₁-C₄-alkyl)SOₓ, (C₁-C₄-haloalkyl)SOₓ, C₁-C₆-alkyl, C₁-C₆-haloalkyl, C₁-C₆-alkoxy or C₁-C₆-haloalkoxy;
R⁸, R⁹ and R¹⁰ are each independently hydrogen or C₁-C₄-alkyl;
R¹¹ is NR¹³R¹⁴,

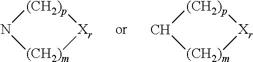

R¹² is

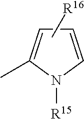

R¹³, R¹⁴, R¹⁵ and R¹⁶ are each independently hydrogen or C₁-C₄-alkyl;
X is O, S or NR¹⁵;
X¹ is chlorine, bromine or fluorine;
r is an integer of 0 or 1;
p and m are each independently an integer of 0, 1, 2 or 3, with the proviso that only one of p, m or r can be 0 and with the further proviso that the sum of p+m+r must be 4, 5 or 6;
x is an integer of 0, 1 or 2; or
the enantiomers or the salts thereof.

In a preferred embodiment Q in formula I is

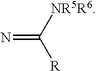

More preferably, the least one N-arylhydrazine derivative is a compound of formula Ia

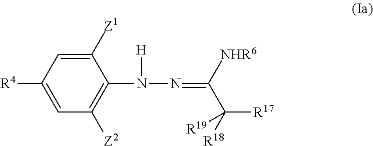

wherein
R⁴ is chlorine or trifluoromethyl;
Z¹ and Z² are each independently chlorine or bromine;
R⁶ is C₁-C₆-alkyl, C₃-C₆-alkenyl, C₃-C₆-alkynyl, or C₃-C₆-cycloalkyl which may be substituted with 1 to 3 halogen atoms, or C₂-C₄-alkyl which is substituted by C₁-C₄-alkoxy;
R¹⁷ and R¹⁸ are each independently C₁-C₆-alkyl, C₃-C₆-alkenyl, C₃-C₆-alkynyl, or C₃-C₆-cycloalkyl which may be substituted with 1 to 3 halogen atoms;
R¹⁹ is hydrogen or C₁-C₆-alkyl;
or enantiomers or salts thereof.

In the definition of formula I and formula Ia shown above, the substituents have the following meanings:

“Halogen” will be taken to mean fluoro, chloro, bromo and iodo.

The term “alkyl” as used herein refers to a branched or unbranched saturated hydrocarbon group having 1 to 4 or 6 carbon atoms, especially C₁-C₆-alkyl such as methyl, ethyl, propyl, 1-methylethyl, butyl, 1-methylpropyl, 2-methylpropyl, 1,1-dimethylethyl, pentyl, 1-methylbutyl, 2-methylbutyl, 3-methylbutyl, 2,2-dimethylpropyl, 1-ethylpropyl, hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl and 1-ethyl-2-methylpropyl.

“Alkoxy” refers to a straight-chain or branched alkyl group having 1 to 4 carbon atoms (methyl, ethyl, propyl, 1-methylethyl, butyl, 1-methylpropyl, 2-methylpropyl, 1,1-dimethylethyl) bonded through an oxygen linkage, at any bond in the alkyl group. Examples include methoxy, ethoxy, propoxy, and isopropoxy.

“Cycloalkyl” refers to a monocyclic 3- to 6-membered saturated carbon atom ring, i.e. cyclopropyl, cyclobutyl, cyclopentyl, and cyclohexyl.

With respect to the intended use of the compounds of formula I, particular preference is given to the following meanings of the substituents, in each case on their own or in combination:

Preference is given to compounds of formula I wherein R⁴ is trifluoromethyl.

Preference is further given to compounds of formula I wherein Z¹ and Z² are both chlorine.

Moreover, preferred are compounds of formula I wherein R⁶ is C₁-C₆-alkyl, especially ethyl.

Preference is further given to compounds of formula I wherein R¹⁷ and R¹⁸ are both methyl.

Moreover, preferred are compounds of formula I wherein R¹⁷ and R¹⁸ form a cyclopropyl ring which is unsubstituted or substituted by 1 to 3 halogen atoms, especially chlorine and bromine.

Moreover, particularly preferred are compounds of formula I wherein R¹⁷ and R¹⁸ form a cyclopropyl ring which is substituted by 2 halogen atoms.

Moreover, particularly preferred are compounds of formula I wherein R¹⁷ and R¹⁸ form a cyclopropyl ring which is substituted by 2 chlorine atoms.

Particularly preferred are compounds of formula I wherein R¹⁷ and R¹⁸ form a 2,2-dichlorocyclopropyl ring.

Preference is further given to compounds of formula I wherein R¹⁹ is C₁-C₆ alkyl, especially methyl.

Particularly preferred are compounds of formula I wherein R¹⁷, R¹⁸ and R¹⁹ are all methyl.

Moreover, particularly preferred are compounds of formula I wherein R¹⁷, R¹⁸ and R¹⁹ form a moiety 1-methyl-2,2-dichlorocyclopropyl.

Preference is further given to compounds of formula I wherein
R⁴ is trifluoromethyl;
Z¹ and Z² are each independently chlorine or bromine;
R⁶ is C₁-C₆-alkyl;
R¹⁷ and R¹⁸ are C₁-C₆-alkyl or may be taken together to form C₃-C₆-cycloalkyl which is substituted by 1 to 2 halogen atoms;
R¹⁹ is C₁-C₆-alkyl;
or the enantiomers or salts thereof.

Particular preference is given to N-ethyl-2,2-dimethylpropionamide-2-(2,6-dichloro-α,α,α-trifluoro-p-tolyl)hydrazone and N-ethyl-2,2-dichloro-1-methylcyclopropanecarboxamide, 2-(2,6-dichloro-α,α,α-trifluoro-p-tolyl)hydrazone.

Furthermore, particular preference with respect to the use in the present invention is given to the compound of formula Ia-1 (N-ethyl-2,2-dimethylpropionamide-2-(2,6-dichloro-α,α,α-trifluoro-p-tolyl)-hydrazone):

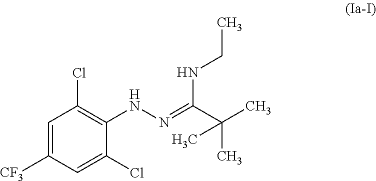 [SMILES: CCN/C(=N\Nc1c(Cl)cc(C(F)(F)F)cc1Cl)C(C)(C)C]

Moreover, particular preference with respect to the use in the present invention is given to the compound of formula Ia-2 (N-Ethyl-2,2-dichloro-1-methylcyclopropanecarboxamide-2-(2,6-dichloro-α,α,α-tri-fluoro-p-tolyl)hydrazone):

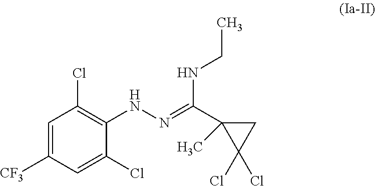 [SMILES: CCN/C(=N\Nc1c(Cl)cc(C(F)(F)F)cc1Cl)C1(C)CC1(Cl)Cl]

With respect to their use, particular preference is given to the compounds Ia-A compiled in the tables below. Moreover, the groups mentioned for a substituent in the tables are on their own, independently of the combination in which they are mentioned, a particularly preferred embodiment of the substituent in question.

With respect to their use, particular preference is also given to the hydrochloric acid, maleic acid, dimaleic acid, fumaric acid, difumaric acid, methane sulfenic acid, methane sulfonic acid, and succinic acid adducts of the compounds of the tables below.

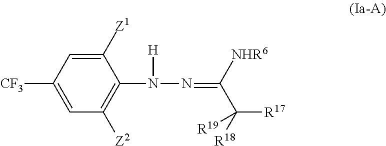

TABLE A

| No. | R⁶ | R¹⁷ | R¹⁸ | R¹⁹ | Z¹ | Z² |
|---|---|---|---|---|---|---|
| A-1 | CH₃ | 2,2-dichlorocyclopropyl | | H | Cl | Cl |
| A-2 | CH₃ | 2,2-dibromocyclopropyl | | H | Cl | Cl |
| A-3 | CH₃ | CH₃ | CH₃ | CH₃ | Cl | Cl |
| A-4 | CH₃ | CH₂CH₃ | CH₃ | CH₃ | Cl | Cl |
| A-5 | CH₃ | 2,2-dichlorocyclopropyl | | CH₃ | Cl | Cl |
| A-6 | CH₃ | 2,2-dibromocyclopropyl | | CH₃ | Cl | Cl |
| A-7 | CH₃ | 2,2-dichlorocyclopropyl | | H | Br | Br |
| A-8 | CH₃ | 2,2-dibromocyclopropyl | | H | Br | Br |
| A-9 | CH₃ | CH₃ | CH₃ | CH₃ | Br | Br |
| A-10 | CH₃ | CH₂CH₃ | CH₃ | CH₃ | Br | Br |
| A-11 | CH₃ | 2,2-dichlorocyclopropyl | | CH₃ | Br | Br |
| A-12 | CH₃ | 2,2-dibromocyclopropyl | | CH₃ | Br | Br |
| A-13 | CH₂CH₃ | 2,2-dichlorocyclopropyl | | H | Cl | Cl |
| A-14 | CH₂CH₃ | 2,2-dibromocyclopropyl | | H | Cl | Cl |
| A-15 | CH₂CH₃ | CH₃ | CH₃ | CH₃ | Cl | Cl |
| A-16 | CH₂CH₃ | CH₂CH₃ | CH₃ | CH₃ | Cl | Cl |
| A-17 | CH₂CH₃ | 2,2-dichlorocyclopropyl | | CH₃ | Cl | Cl |
| A-18 | CH₂CH₃ | 2,2-dibromocyclopropyl | | CH₃ | Cl | Cl |
| A-19 | CH₂CH₃ | 2,2-dichlorocyclopropyl | | H | Br | Br |
| A-20 | CH₂CH₃ | 2,2-dibromocyclopropyl | | H | Br | Br |
| A-21 | CH₂CH₃ | CH₃ | CH₃ | CH₃ | Br | Br |
| A-22 | CH₂CH₃ | CH₂CH₃ | CH₃ | CH₃ | Br | Br |
| A-23 | CH₂CH₃ | 2,2-dichlorocyclopropyl | | CH₃ | Br | Br |
| A-24 | CH₂CH₃ | 2,2-dibromocyclopropyl | | CH₃ | Br | Br |
| A-25 | CH₂CH₂CH₃ | 2,2-dichlorocyclopropyl | | H | Cl | Cl |
| A-26 | CH₂CH₂CH₃ | 2,2-dibromocyclopropyl | | H | Cl | Cl |
| A-27 | CH₂CH₂CH₃ | CH₃ | CH₃ | CH₃ | Cl | Cl |
| A-28 | CH₂CH₂CH₃ | CH₂CH₃ | CH₃ | CH₃ | Cl | Cl |
| A-29 | CH₂CH₂CH₃ | 2,2-dichlorocyclopropyl | | CH₃ | Cl | Cl |
| A-30 | CH₂CH₂CH₃ | 2,2-dibromocyclopropyl | | CH₃ | Cl | Cl |
| A-31 | CH₂CH₂CH₃ | 2,2-dichlorocyclopropyl | | H | Br | Br |
| A-32 | CH₂CH₂CH₃ | 2,2-dibromocyclopropyl | | H | Br | Br |
| A-33 | CH₂CH₂CH₃ | CH₃ | CH₃ | CH₃ | Br | Br |

Preferred insecticides and/or repellents of the pesticidal composition of the invention may be either one or a mixture. One embodiment is mixtures of pesticides with differing molecular sizes and/or differing physicochemical properties. Preferred mixtures of pesticides are mixtures of insecticides and/or repellents with similar diffusion/migration properties. This group of insecticides and/or repellents may include synthetic pyrethroids such as alphacypermethrin, cyfluthrin, deltamethrin, etofenprox and permethrin, other pyrethroids such as bifenthrine, and non-pyrethroids such as carbosulphane and chlorfenapyr. In a preferred embodiment, a mixture of alpha-cypermethrin and chlorfenapyr is used.

The pesticide can also be included in the pesticidal composition as one of a water-based pesticide concentrate or a solvent, preferably an organic solvent, based pesticide concentrate or a concentrate based on a mixture of water and a solvent, preferably an organic solvent. Water-based concentrates may be in the form of suspensions or dispersions comprising suitable dispersing agents if necessary or in the form of emulsions comprising emulsifiers, solvents and co-solvents if appropriate. Nanoparticular pesticidal formulations may be obtained by dissolving solid solutions of pesticidal in a polar organic solvent, e.g. poly vinyl pyrrolidone (PVP). The concentration of the pesticide in the water based or solvent based concentrates is in general between 0.5 to 60%, preferably 1 to 40%, more preferably 3 to 20%.

The particle size of the pesticide in water-based suspensions or dispersions is in general between 50 nm to 20 μm, preferably 50 nm to 8 μm, more preferably 50 nm to 4 μm, most preferably 50 nm to 500 nm.

### Polymeric Binder (Component B)

The polymeric binder (component B) may be any polymeric binder known in the art. Especially preferred are polymeric binders used in the area of impregnating or coating textile materials or plastics materials.

Preferred binders are for example binders obtainable by polymerization, preferably radical polymerization, of at least one ethylenically unsaturated monomer selected from the group consisting of acrylates, preferably C₁-C₁₂-esters of acrylic acid or acrylates having crosslinked ester functionalities, methacrylates, preferably C₁-C₁₂-esters of methacrylic acid or methacrylates having crosslinked ester functionalities, acrylic acid, methacrylic acid, acrylonitrile, maleic acid, maleic acid anhydride, mono or diesters of maleic acid, styrene, derivatives of styrene such as methyl styrene, butadiene, vinyl acetate, vinyl alcohol, ethylene, propylene, allylic alcohol, vinyl pyrrolidone, vinyl chloride and vinyl dichloride.

The polymerization, preferably radical polymerization, may be carried out for example as bulk polymerization, gas phase polymerization, solvent polymerization, emulsion polymerization or suspension polymerization.

The conditions and further necessary and suitable components for the preparation of suitable polymers by polymerization, preferably radical polymerization, of the monomers mentioned above are known by a person skilled in the art.

Suitable polymeric binders obtained by polymerization, preferably radical polymerization, of the above-mentioned monomers are homopolymers or copolymers, preferably selected from the group consisting of polyacrylates, polymethacrylates, polyacrylonitrite, polymaleic acid anhydride, polymaleic acid, polymaleic acid esters, and polymaleic acid amides, polystyrene, poly(methyl)styrene, polybutadiene, polyvinylacetate, polyvinylalcohol as well as copolymers obtained by polymerization of at least two different ethylenically unsaturated monomers of the group of monomers mentioned above and blends of said homopolymers and/or copolymers, for example poly(styrene-acrylates), poly(styrene-butadiene), ethylene-acrylate-copolymers, ethylene-vinylacetate-copolymers, which may be partially or completely hydrolyzed.

Further suitable polymeric binders are selected from polyurethanes and/or polyisocyanurates, blends comprising polyurethanes and/or polyisocyanurates, preferable blends comprising polyurethanes and/or polyisocyanurates and polycarbonates;
mineral waxes, zirconium waxes, silicones, polysiloxanes, fluorinated polyacrylates and methacrylates, fluorosilicones, and
fluorocarbon resins (as disclosed e.g. in WO 01/37662 and WO 92/16103);
melamine formaldehyde condensation resins, methylol urea derivatives; and curable polyesters; or
blends or preparations comprising at least one of said polymeric binders.

The polymeric binders mentioned above are known in the art and are either commercially available or can be prepared by preparation processes known in the art.

Further suitable polymeric binders are polyvinylacetates in a formulation comprising a thickener like carboxymethyl cellulose and optionally a cross linking agent like a melamine resin; curable polyesters; formulations comprising reactive silicones (organic polysiloxanes), polyvinyl alcohol, polyvinyl acetate or an acrylic copolymer.

The crosslinking may be carried out thermally or by UV-light or by the dual cure technique. Optionally, a catalyst or a crosslinking agent may be used together with the polymeric binder.

Preferred polymeric binders are selected from the group consisting of acrylic binders and polyurethane and/or polyisocyanurate binders.

Most preferred polymeric binders are acrylic binders, which are optionally fluorinated. Especially preferred acrylic binders are mentioned below (component B1).

### Acrylic Binders (Component B1)

Most preferred are acrylic binders, which may be hompolymers or copolymers, wherein the copolymers are preferred.

The acrylic binders are preferably obtained by radical polymerization, more preferably radical emulsion polymerization, of at least one monomer of formula II as component B1A

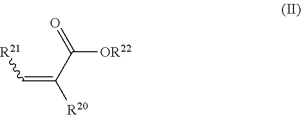

wherein
R²⁰, R²¹ and R²² are independently selected from C₁- to C₁₀-alkyl, which is optionally fluoro substituted and which may be linear or branched, for example methyl, ethyl, n-propyl, i-propyl, n-butyl, i-butyl, sec-butyl, t-butyl, n-pentyl, i-pentyl, sec-pentyl, neo-pentyl, 1,2-dimethylpropyl, i-amyl, n-hexyl, i-hexyl, sec-hexyl, n-heptyl, n-octyl, 2-ethylhexyl, n-nonyl, n-decyl, preferably C₁- to C₄-alkyl, for example methyl, ethyl, n-propyl, i-propyl, n-butyl, i-butyl, sec-butyl, tert-butyl; substituted or unsubstituted aryl, preferably substituted or unsubstituted C₆- to C₁₀-aryl, more preferably substituted or unsubstituted C₆-aryl, for example phenyl or tolyl;
R²⁰ and R²¹ may further be H.

Preferably R²⁰ is H or methyl. R²¹ is preferably H; R²² is preferably methyl, ethyl, n-butyl or 2-ethylhexyl.

More preferably R²⁰ is H or methyl, R²¹ is H and R²² is methyl, ethyl, n-butyl or 2-ethylhexyl.

Most preferably the monomer of formula II (component BA) is selected from the group consisting of 2-ethylhexylacrylate, n-butylacrylate, methylacrylate, methylmethacrylate and ethylacrylate. Most preferably a copolymer obtainable by polymerization of at least two different acrylic monomers of formula II is employed.

Most preferably an acrylic binder is used as component B obtainable by emulsion polymerization of
b1 a) at least one monomer of formula II as component B1A

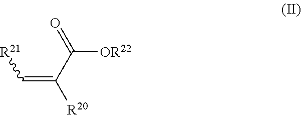

wherein
R²⁰, R²¹ and R²² are independently selected from C₁- to C₁₀-alkyl which may be linear or branched, for example methyl, ethyl, n-propyl, i-propyl, n-butyl, i-butyl, sec-butyl, t-butyl, n-pentyl, i-pentyl, sec-pentyl, neo-pentyl, 1,2-dimethylpropyl, i-amyl, n-hexyl, i-hexyl, sec-hexyl, n-heptyl, n-octyl, 2-ethylhexyl, n-nonyl, n-decyl, preferably C₁- to C₄-alkyl, for example methyl, ethyl, n-propyl, i-propyl, n-butyl, i-butyl, sec-butyl, tert-butyl; substituted or unsubstituted aryl, preferably substituted or unsubstituted C₆- to C₁₀-aryl, more preferably substituted or unsubstituted C₆-aryl, for example phenyl or tolyl;
R²⁰ and R²¹ may further be H.

Preferably R²⁰ is H or methyl. R²¹ is preferably H; R²² is preferably methyl, ethyl, n-butyl or 2-ethylhexyl.

More preferably R²⁰ is H or methyl, R²¹ is H and R²² is methyl, ethyl, n-butyl or 2-ethylhexyl
b1b) at least one monomer of formula III as component B1B

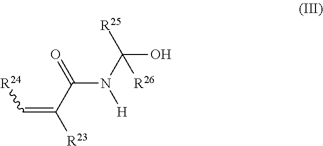

wherein
R²³, R²⁴, R²⁵ and R²⁶ are independently selected from the group consisting of H, C₁- to C₁₀-alkyl which may be linear or branched, for example, methyl, ethyl, n-propyl, propyl, n-butyl, i-butyl, sec-butyl, tert-butyl, n-pentyl, i-pentyl, sec-pentyl, neo-pentyl, 1,2-dimethylpropyl, i-amyl, n-hexyl, i-hexyl, sec-hexyl, n-heptyl, n-octyl, 2-ethylhexyl, n-nonyl and n-decyl; preferably R²³, R²⁴, R²⁵ and R²⁶ are selected from the group consisting of H, C₁- to C₄-alkyl, which may be linear or branched, for example methyl, ethyl, n-propyl, iso-propyl, n-butyl, i-butyl, sec-butyl and tert-butyl; substituted or unsubstituted aryl, preferably substituted or unsubstituted C₆- to C₁₀-aryl, more preferably substituted or unsubstituted C₆-aryl, for example phenyl or tolyl;
more preferably R²³ is H or methyl, R²⁴, R²⁵ and R²⁶ are preferably independent of each other H;
most preferably R²³ is H or methyl and R²⁴, R²⁵ and R²⁶ are H;
b1 c) optionally at least one monomer of formula IV as component B1C

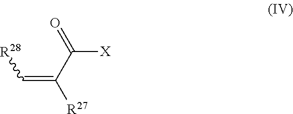

wherein
R²⁷ and R²⁸ are independently selected from the group consisting of H, C₁- to C₁₀-alkyl which may be linear or branched, for example, methyl, ethyl, n-propyl, i-propyl, n-butyl, i-butyl, sec-butyl, tert-butyl, n-pentyl, i-pentyl, sec-pentyl, neo-pentyl, 1,2-dimethylpropyl, i-amyl, n-hexyl, i-hexyl, sec-hexyl, n-heptyl, n-octyl, 2-ethylhexyl, n-nonyl and n-decyl; preferably R²⁷ and R²⁸ are selected from the group consisting of H, C₁- to C₄-alkyl, which may be linear or branched, for example methyl, ethyl, n-propyl, iso-propyl, n-butyl, i-butyl, sec-butyl and tert-butyl; substituted or unsubstituted aryl, preferably substituted or unsubstituted C₆- to C₁₀-aryl, more preferably substituted or unsubstituted C₆-aryl, for example phenyl or tolyl;
most preferably R²⁷ and R²⁸ are H;
X is selected from the group consisting of H, OH, NH₂, OR²⁹OH, glycidyl, hydroxypropyl,

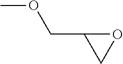

groups of the formula

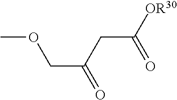

wherein
R³° is selected from the group consisting of C₁- to C₁₀-alkyl which may be branched or linear, for example methyl, ethyl, n-propyl, i-propyl, n-butyl, i-butyl, sec-butyl, tert-butyl, n-pentyl, i-pentyl, sec-pentyl, neo-pentyl, 1 ,2-dimethylpropyl, i-amyl, n-hexyl, i-hexyl, sec-hexyl, n-heptyl, n-octyl, 2-ethylhexyl, n-nonyl, n-decyl; preferably C₁- to C₄-alkyl, which may be branched or linear, for example methyl, ethyl, n-propyl, iso-propyl, n-butyl, iso-butyl, sec-butyl and tert-butyl; substituted or unsubstituted aryl, preferably substituted or unsubstituted C₆- to C₁₀-aryl, more preferably substituted or unsubstituted C₆-aryl, for example phenyl or tolyl;
R²⁹ is selected from the group consisting of C₁- to C₁₀-alkylene, for example methylene, ethylene, propylene, butylene, pentylene, hexylene, heptylene, octylene, nonylene, decylene; preferably C₁- to C₄-alkylene, for example methylene, ethylene, propylene, butylenes; substituted or unsubstituted arylenes, preferably substituted or unsubstituted C₆- to C₁₀-arylene, more preferably substituted or unsubstituted C₆-arylene, for example phenylene; most preferably X is acetoacetyl;
b1d) further monomers which are copolymerizable with the monomers mentioned above selected from
   b1d1) polar monomers, preferably (meth)acrylic nitrile and/or methyl(meth)acrylate as component B1D1; and/or
   b1d2) non polar monomers, preferably styrene and/or a-methylstyrene as component B1D2.

The acrylic binder is preferably obtainable by emulsion polymerization of
b1a) 10 to 95% by weight, preferably 30 to 95% by weight, more preferably 50 to 90% by weight of component B1A;
b1b) 1 to 5% by weight of component B1B;
b1c) 0 to 5% by weight, preferably 1 to 4% by weight, more preferably 0.2 to 3% by weight of component B1C;
b1d) further monomers which are copolymerizable with the monomers mentioned above selected from
   b1d1) 0 to 30% by weight, preferably 0 to 25% by weight, more preferably 5 to 20% by weight of component B1D1; and/or
   b1d2) 0 to 40% by weight, preferably 0 to 30% by weight, more preferably 5 to 20% by weight of component B1D2;
      wherein the sum of the components B1A, B1B and optionally B1C and B1D is 100% by weight.

In a further preferred embodiment the acrylic binder is obtainable by emulsion polymerization of
b1a) 10 to 95% by weight, preferably 30 to 95% by weight, more preferably 50 to 90 by weight of at least one acrylic binder (component B1A) as defined above, comprising
   b1a1) 10 to 90% by weight, preferably 15 to 85% by weight, more preferably 30 to 85% by weight based on the acrylic binder of n-butyl acrylate;
   b1a2) 10 to 90% by weight, preferably 12 to 85% by weight, more preferably 15 to 65% by weight based on the acrylic binder of at least one monomer of formula II, different from n-butyl acrylate;
b1b) 1 to 5% by weight based on the acrylic binder of at least one monomer of formula III (component B1B);
b1c) 0 to 5% by weight, preferably 0.1 to 4% by weight, more preferably 0.2 to 3% by weight based on the acrylic binder of at least one monomer of formula III (component B1C);
b1d) further monomers which are copolymerizable with the monomers mentioned (component B1D) above selected from
   b1d1) 0 to 30% by weight, preferably 0 to 25% by weight, more preferably 5 to 20% by weight based on the acrylic binder of at least one polar monomer, preferably (meth)acrylic nitrile and/or methyl(meth)acrylate (component B1D1); and/or
   b1d2) 0 to 40% by weight, preferably 0 to 30% by weight, more preferably 5 to 20% by weight based on the acrylic binder of at least one non polar monomer, preferably styrene and/or a-methylstyrene (component B1D2);
      wherein the sum of the components B1A, B1B and optionally B1C and B1D is 100% by weight.

The acrylic binder may comprise further additives as known by a person skilled in the art, for example film forming agents and plasticizers, e.g. adipate, phthalate, butyl diglycol, mixtures of diesters preparable by reaction of dicarboxylic acids and alcohols which may be linear or branched. Suitable dicarboxylic acids and alcohols are known by a person skilled in the art.

The insecticide compositions comprising the binder as claimed in the present invention are weather resistant while permitting continuous release of the insecticide at a controlled rate, in order to provide the required bioavailability of the insecticide. It is not necessary to add for example a dispersing agent that, after application of the composition to a fabric and upon wetting of the fabric, reduces the hydrophobicity imparted to the insecticide by the binder to permit limited insecticide release. Preferably, the insecticide composition of the present invention does therefore not comprise a dispersing agent in addition to the polymeric binder.

Most preferably the acrylic binder is obtainable by emulsion polymerization of the following components:
b1 a) 50 to 90% by weight of at least one monomer of formula II as component B1A

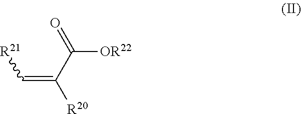

wherein
R²⁰ is H or methyl, R²¹ is H and R²² is methyl, ethyl, n-butyl, or 2-ethylhexyl, as component B1A, most preferably component B1A is 2-ethylhexylacrylate, n-butylacrylate, methylacrylate, methylmethacrylate or ethylacrylate;
b1b) 1 to 5% by weight of at least one monomer of formula III

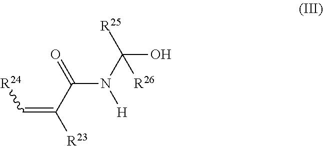

wherein R²³ is H or methyl, R²⁴, R²⁵ and R²⁶ each are H as component B1B;
b1c) 1 to 10% by weight, preferably 1 to 7% by weight, more preferably 2 to 5% by weight of at least one monomer of formula IV

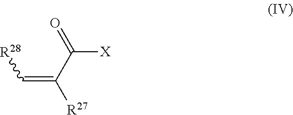

wherein R²⁷ and R²⁸ are H and X is H, OH, NH₂, OR²⁹OH, glycidyl or a group of the formula

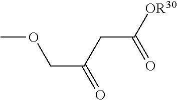

wherein R³⁰ is selected from the group consisting of C₁- to C₁₀-alkyl which may be branched or linear, for example methyl, ethyl, n-propyl, i-propyl, n-butyl, i-butyl, sec-butyl, tert-butyl, n-pentyl, i-pentyl, sec-pentyl, neo-pentyl, 1,2-dimethylpropyl, i-amyl, n-hexyl, i-hexyl, sec-hexyl, n-heptyl, n-octyl, 2-ethylhexyl, n-nonyl, n-decyl; preferably C₁- to C₄-alkyl, which may be branched or linear, for example methyl, ethyl, n-propyl, iso-propyl, n-butyl, iso-butyl, sec-butyl and tert-butyl; substituted or unsubstituted aryl, preferably substituted or unsubstituted C₆- to C₁₀-aryl, more preferably substituted or unsubstituted C₆-aryl, for example phenyl or tolyl;
R²⁹ is selected from the group consisting of C₁- to C₁₀-alkylene, for example methylene, ethylene, propylene, butylene, pentylene, hexylene, heptylene, octylene, nonylene, decylene; preferably C₁- to C₄-alkylene, for example methylene, ethylene, propylene, butylenes; substituted or unsubstituted arylenes, preferably substituted or unsubstituted C₆- to C₁₀-arylene, more preferably substituted or unsubstituted C₆-arylene, for example phenylene;
as component B1C, most preferably X is acetoacetyl;
b1d) further monomers which are copolymerizable with the monomers mentioned above selected from
   b1d1) 0 to 30% by weight, preferably 0 to 25% by weight, more preferably 5 to 20% by weight of component B1D1, preferably (meth)acrylic nitrile and/or methyl(meth)acrylate; and/or
   b1d2) 0 to 40% by weight, preferably 0 to 30% by weight, more preferably 5 to 20% by weight of component BD2, preferably styrene and/or a-methylstyrene;
      wherein the sum of components BA, BB and optionally BC and BD is 100% by weight.

In a further most preferred embodiment the amount of n-butylacrylate as component BA is from 30 to 90% by weight, and the other components B1B and optionally a further monomer of formula II (component B1A), B1C and B1D are chosen as mentioned before, wherein the sum of components B1A, B1B and optionally B1C and B1D is 100% by weight.

The acrylic binder of the present invention is preferably obtainable by emulsion polymerization of the monomers mentioned before. Suitable process conditions are known by a person skilled in the art, and are disclosed e.g., in WO-A 2005/064072.

In the acrylic binder according to the invention, it is possible to add in general up to 10% by weight, preferably 0.05 to 5% by weight of mono- or di-olefinically unsaturated monomers containing reactive or cross-linking groups. Examples of such monomers are in particular the amides of α,β-olefinically unsaturated C₃₋₅-carboxylic acids, particularly acryl amides, methacryl amides and maleic diamides, and their N-methylol derivatives such as N-methylol acrylic amide, N-methylol methacrylic amide, N-alkoxy methyl amides of α,β-monoolefinically unsaturated C₃₋₅-carboxylic acids such as N-methoxy methacrylic amide and N-n-butoxymethylacrylic amide, vinyl sulfonic acid, monoesters of acrylic and methacrylic acids with alkanediols such as glycol, butanediol-1,4, hexane diol-1,6, and 3-chloropropanediol-1,2, and also allyl and methallyl esters of α,β-olefinically unsaturated mono- and di-carboxylic acids such as diallyl maleate, dimethyl allyl fumarate, allyl acrylate and allyl methacrylate, diallyl phthalate, diallyl terephthalate, p-di-vinyl benzene, methylene-bis-acrylamide and ethylene glycol di-allylether.

The molecular weight of the non crosslinked emulsion polymers obtained is in general 40,000 to 250,000 (determined by GPC). The molecular weight is usually controlled by the use of conventional chain stoppers in conventional amounts. Conventional chain stoppers are for example sulfoorganic compounds.

The acrylic binder of the present invention is obtained in form of its aqueous dispersion and is preferably employed in the insecticide compositions of the present invention in form of the aqueous dispersion.

Polyurethane Binders and/or Polyisocyanurate Binders (Component B2)

In a further preferred embodiment the polymeric binders are polyurethanes and/or polyisocyanurates. Said polyurethanes and/or polyisocyanurates may be employed either alone as polymeric binders or in combination with further polymeric binders, especially polymeric binders mentioned before, for example in combination with the acrylic binders mentioned before.

Suitable polymeric binders are therefore:

at least one polyurethane as component B2, obtainable by reaction of the following components:
b2a) at least one diisocyanate or polyisocyanate as component B2A, preferably aliphatic, cycloaliphatic, araliphatic and/or aromatic insocyanates, more preferably diisocyanates, which are optionally biuretisized and/or isocyanurized, most preferably 1-isocyanato-3,3,5-trimethyl-5-isocyanatomethylene cyclohexane (IPDI) and hexamethylene diisocyanate-1,6 (HMDI);
b2b) at least one diol, triol or polyol as component B2B, preferably aliphatic, cycloaliphatic and/or araliphatic diols having 2 to 14, preferably 4 to 10 carbon atoms, more preferably 1,6-hexanediol or neopentyl glycol;
b2c) optionally further components as component B2C, preferably adipic acid or carbonyl diimidazole (CDI); and
b2d) optionally further additives as component B2D.

The polyurethane is preferably obtainable by reaction of the following components:
b2a) 55 to 99% by weight, preferably 70 to 98% by weight, more preferably 75 to 90 by weight based on the polyurethane of at least one diisocyanate or polyisocyanate (component B2a), preferably aliphatic, cycloaliphatic, araliphatic and/or aromatic insocyanates, more preferably diisocyanates, which are optionally biuretisized and/or isocyanurized, more preferably alkylene diisocyanates having from 4 to 12 carbon atoms in the alkylene unit, like 1,12-dodecane diisocyanate, 2-ethyltetramethylene diisocyanate-1,4, 2-methylpentamethylene diisocyanate-1,5, tetramethylene diisocyanate-1,4, lysinester diisocyanate (LDI), hexamethylene diisocyanate-1,6 (HMDI), ciclohexane-1,3- and/or -1,4-diisocyanate, 2,4-and 2,6-hexahydro-toluylene diisocyanate as well as the corresponding isomeric mixtures 4,4′-2,2′- and 2,4′-dicyclohexylmethane diisocyanate as well as the corresponding mixtures, 1-isocyanato-3,3,5-trimethyl-5-isocyanatomethyl cyclohexane (IPDI), 2,4- and/or 2,6-toluylene diisocyanate, 4,4′-, 2,4′ and/or 2,2′-diphenylmethane diisocyanate (monomeric MDI), polyphenylpolymethylene polyisocyanate (polymeric MDI) and/or mixtures comprising at least 2 of the isocyanates mentioned before; further ester-, urea-, allophanate-, carbodiimid-, uretdione- and/or urethane groups comprising di- and/or polyisocyanates may be used; most preferably 1-isocyanato-3,3,5-trimethyl-5-isocyanatomethylene cyclohexane (IPDI) and hexamethylene diisocyanate-1,6 (HMDI);
b2b) 10 to 90% by weight, preferably 12 to 85% by weight, more preferably 15 to 65% by weight based on the polyurethane of at least one diol, triol or polyol (component B2B), preferably aliphatic, cycloaliphatic and/or araliphatic diols having 2 to 14, preferably 4 to 10 carbon atoms, more preferably polyols, selected from the group consisting of polyetherols, e.g. polytetrahydrofurane, polyesterols, polythioetherpolyols, hydroxyl group containing polyacetales and hydroxyl group containing aliphatic polycarbonates or mixtures of at least 2 of the polyols mentioned before. Preferred are polyesterols and/or polyetherols. The hydroxyl number of the polyhydroxy compounds is in general from 20 to 850 mg KOH/g and preferably 25 to 80 mg KOH/g. Further, diols and/or triols having a molecular weight of from in general 60 to <400, preferably from 60 to 300 g/mol are employed. Suitable diols are aliphatic, cycloaliphatic and/or araliphatic diols having from 2 to 14, preferably 4 to 10 carbon atoms, e.g. ethylene glycol, propane diol-1,3, decane diol-1,10, o-, m-, p-dihydroxycyclohexane, diethylene glycol, dipropylene glycol and preferably butane diol-1,4, neopentyl glycol, hexane diol-1,6 and bis-(2-hydroxy-ethyl)hydroquinone, triols, like 1,2,4-, 1,3,5-trihydroxy-cyclohexane, glycerine and trimethylol propane and mixtures of low molecular hydroxyl groups containing polyalkylene oxides based on ethylene oxide and/or 1,2-propylene oxide and the diols and/or triols mentioned before;
b2c) 0 to 10% by weight, preferably 0.1 to 5% by weight, more preferably 1 to 5% by weight based on the polyurethane of further components (component B2C), preferably adipic acid or carbonyl diimidazole (CDI); and
b2d) 0 to 10% by weight, preferably 0.1 to 5% by weight, more preferably 0.5 to 5% by weight based on the polyurethane of further additives (component B2D);
   wherein the sum of the components B2A, B2B, B2C and B2D is 100% by weight.

The polyurethanes are prepared by methods known in the art. Further, additives as known by a person skilled in the art may be used in the process for preparing the polyurethanes.

Component B may also be a polyisocyanurate or a mixture of a polyisocyanurate and a polyurethane, preferably a polyurethane as mentioned above.

Polyisocyanurates are polymers comprising groups of the following formula:

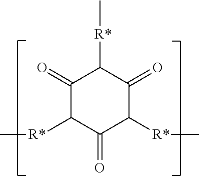

wherein R* is an alkylene or arylene residue depending on the isocyanate employed in the preparation of the isocyanurate.

Polyisocyanurates are usually prepared by cyclotrimerization of isocyanates. Preferred isocyanates are the same isocyanates as mentioned before (component B2A). Preparation processes and conditions for the preparation of polyisocyanurates are known by a person skilled in the art.

### Pesticidal Compositions

The pesticidal compositions of the invention may be aqueous compositions or dry compositions, i.e. compositions which do not comprise water.

In a preferred embodiment the pesticidal compositions are aqueous compositions, preferably comprising 55 to 97% by weight, more preferably 85 to 95% by weight of water, and 3 to 45% by weight, preferably 5 to 15% by weight of solids, based on the total of the components in the insecticide compositions of the present invention, wherein the total is 100% by weight. The solids are preferably selected from the group consisting of at least one pesticide as component A as defined above, and at least one polymeric binder as component B as defined above, and optionally at least one fixative agent as component C as defined below, and optionally further components depending on the use of the final product as defined above.

The treatment baths from which the pesticidal compositions are applied to the material are preferably aqueous formulations comprising 95 to 99.5% by weight, preferably 95 to 99% by weight, more preferably 97 to 99% by weight of water, and 0.5 to 5% by weight, preferably 1 to 5% by weight of solids, based on the total of the components in the insecticidal compositions of the present invention. The solids are preferably selected from the group consisting of at least one pesticidal compound of formula I as component A as defined above, and at least one polymeric binder as component B as defined above, and optionally at least one fixative agent as component C as defined below, and optionally further components depending on the use of the final product as defined above.

The polymeric binder may advantageously be applied with a fixative agent C for improved attachment of the pesticide on the material. The fixative agent may comprise free isocyanate groups.

Suitable fixable agents are for example isocyanates or isocyanurates comprising free isocyanate groups. Preferably the isocyanurates are based on alkylene diisocyanates having from 4 to 12 carbon atoms in the alkylene unit, like 1,12-dodecane diisocyanate, 2-ethyltetramethylene diisocyanate-1,4, 2-methylpentamethylene diisocyanate-1,5, tetramethylene diisocyanate-1,4, lysinester diisocyanate (LDI), hexamethylene diisocyanate-1,6 (HMDI), cyclohexane-1,3- and/or -1,4-diisocyanate, 2,4- and 2,6-hexahydrotoluylene diisocyanate as well as the corresponding isomeric mixtures 4,4′-2,2′- and 2,4′-dicyclohexylmethane diisocyanate as well as the corresponding mixtures, 1-isocyanato-3,3,5-trimethyl-5-isocyanatomethyl cyclohexane (IPDI), 2,4- and/or 2,6-toluylene diisocyanate, 4,4′-, 2,4′ and/or 2,2′-diphenylmethane diisocyanate (monomeric MDI), polyphenylpolymethylene polyisocyanate (polymeric MDI) and/or mixtures comprising at least 2 of the isocyanates mentioned before. More preferably the isocyanurates are based on hexamethylene diisocyanate-1,6 (HMDI).

More preferably the isocyanurate is a isocyanurate which is hydrophilized with a polyalkylene oxide based on ethylene oxide and/or 1,2-propylene oxide, preferably polyethylene oxide.

The isocyanurate used as a fixative agent can be prepared by methods known in the art. Preferably 5 to 25% by weight, more preferably 7 to 20% by weight, most preferably 10 to 15% by weight of the isocyanate groups based on the amount of isocyanate used as staring material for the preparation of the isocyanurate are free isocyanate groups.

Most preferably the isocyanurate used as a fixative agent is dissolved in a polar aprotic solvent, e.g. THF, DMF or propylene or ethylene carbonate.

The most preferred fixative agent used is an isocyanurate based on HMDI which are hydrophilized with a polyethylene oxide and which is dissolved in propylene carbonate (70% by weight of HMDI in 30% by weight of propylene carbonate). The amount of free isocyanate groups is 11 to 12% by weight, based on the amount of isocyanate used as staring material for the preparation of the isocyanurate.

The pesticidal composition preferably comprises the following components, based on the solids content of the composition, if a fixative agent is used:
a) 20 to 70% by weight, preferably 25 to 65% by weight, more preferably 30 to 65% by weight of at least one pesticide (component A), and
b) 29 to 72% by weight, preferably 34 to 70% by weight, more preferably 33 to 66 by weight of at least one polymeric binder (component B) as defined above;
c) 1 to 8% by weight, preferably 1 to 5% by weight, more preferably 2 to 4% by weight of at least one fixative agent (component C);
   wherein the sum of the components is 100% by weight of solids content of the pesticide composition.

Depending on the use of the final product the pesticidal composition may further comprise one or more components selected from water, preservatives, detergents, fillers, impact modifiers, anti-fogging agents, blowing agents, clarifiers, nucleating agents, coupling agents, conductivity-enhancing agents (antistats), stabilizers such as anti-oxidants, carbon and oxygen radical scavengers and peroxide decomposing agents and the like, flame retardants, mould release agents, agents having UV protecting properties, optical brighteners, spreading agents, anti-blocking agents, anti-migrating agents, anti-foam agents, anti-soiling agents, thickeners, further biocides, wetting agents, plasticizers and film forming agents, adhesive or anti-adhesive agents, optical brightening (fluorescent whitening) agents, fragrance, pigments and dyestuffs.

Suitable anti-foam agents are for example silicon anti-foam agents. Suitable UV-protecting agents for protecting UV-sensitive insecticides and/or repellents are for example para-aminobenzoic acids (PABA), octylmethoxysinameth, stilbenes, styryl or benzotriazole derivatives, benzoxazol derivatives, hydroxy-substituted benzophenones, salicylates, substituted triazines, cinnamic acid derivatives (optionally substituted by 2-cyano groups), pyrazoline derivatives, 1,1′-biphenyl-4,4′-bis-2-(methoxyphenyl)-ethenyl or other UV protecting agents. Suitable optical brighteners are dihydroquinolinone derivatives, 1,3-diaryl pyrazoline derivatives, pyrenes, naphthalic acid imides, 4,4′-diystyryl biphenylene, 4,4′-diamino-2,2′-stilbene disulphonic acids, cumarin derivatives and benzoxazole, benzisoxazole or benzimidazole systems which are linked by —CH═CH-bridges or other fluorescent whitening agents.

Typical pigments used in the pestidical compositions of the present invention are pigments which are used in pigment dyeing or printing processes or are applied for the coloration of plastics and are known by a person skilled in the art.

Pigments may be inorganic or organic by their chemical nature. Inorganic pigments are mainly used as white pigments (e.g., titanium dioxide in the form of rutile or anatas, ZnO, chalk) or black pigments (e.g., carbon black). Colored inorganic pigments may be used as well but are not preferred because of potential toxicologic hazards. For imparting color, organic pigments or dyestuffs are preferred. Organic pigments may be mono or disazo, naphthol, benzimidazolone, (thio) indigoid, dioxazine, quinacridone, phthalocyanine, isoindolinone, perylene, perinone, metal complex or diketo pyrrolo pyrrole type pigments. Pigments may be used in powder or liquid form (i.e., as a dispersion). Preferred pigments are Pigment Yellow 83, Pigment Yellow 138, Pigment Orange 34, Pigment Red 170, Pigment Red 146, Pigment Violet 19, Pigment Violet 23, Pigment Blue 15/1, Pigment Blue 15/3, Pigment Green 7, Pigment Black 7. Other suitable pigments are known to a person skilled in the art.

Typical dyestuffs which may be used in the present invention are vat dyes, cationic dyes and disperse dyes in powder or liquid form. Vat dyes may be used as pigments or following the vatting (reduction) and oxidation procedure. Using the vat pigment form is preferred. Vat dyes may be of the indanthrone type, e.g. C.I. Vat Blue 4, 6 or 14; or of the flavanthrone type, e.g. C.I. Vat Yellow 1; or of the pyranthrone type, e.g. C.I. Vat Orange 2 and 9; or of the isobenzanthrone (isoviolanthrone) type, e.g. C.I. Vat Violet 1; or of the dibenzanthrone (violanthrone) type, e.g. C.I. Vat Blue 16, 19, 20 and 22, C.I. Vat Green 1, 2 and 9, C.I. Vat Black 9; or of the anthraquinone carbazole type, e.g. C.I. Vat Orange 11 and 15, C.I. Vat Brown 1, 3 and 44, C.I. Vat Green 8 and C.I. Vat Black 27; or of the benzanthrone acridone type, e.g. C.I. Vat Green 3 and 13 and C.I. Vat Black 25; or of the anthraquinone oxazole type, e.g. C.I. Vat Red 10; or of the perylene tetra carbonic acid diimide type, e.g. C.I. Vat Red 23 and 32; or imidazole derivatives, e.g. C.I. Vat Yellow 46; or amino triazine derivatives, e.g. C.I. Vat Blue 66. Other suitable vat dyes are known by a person skilled in the art.

Typical disperse and cationic dyestuffs are known by a person skilled in the art.

If cellulosic substrates are employed as material, said cellulosic substrates are preferably dyed with vat, direct, reactive or sulphur dyestuffs.

In a further embodiment the pesticidal compositions of the present invention are pesticidal compositions as mentioned before comprising at least one pigment and/or at least one dyestuff. The pesticidal compositions of the present invention preferably comprise 10 to 300% by weight, more preferably 20 to 150% by weight of the pigment and/or dyestuff relating to the total weight of the solids content of the pesticide.

The material, for example textile material or plastics material, may be impregnated (meaning, e.g., dyed or otherwise processed) prior to use if the composition is delivered in the form of a kit.

In a further embodiment, the impregnated material according to the present invention further comprises one or more components selected from preservatives, detergents, stabilizers, agents having UV-protecting properties, optical brighteners, spreading agents, anti-migrating agents, anti-foam agents, wetting agents, anti-soiling agents, thickeners, further biocides, plasticizers, adhesive agents, pigments and dyestuffs. Suitable examples of the components mentioned above are known to a person skilled in the art.

In a further embodiment of the present invention the impregnated material comprises besides the at least one pesticide and the at least one polymeric binder as described before at least one pigment and/or at least one dyestuff. The amount of the at least one pigment is in general from 0.05 to 10% by weight, preferably 0.1 to 5% by weight, more preferably 0.2 to 3.5% by weight of the (dry) weight of the non-living material. The amount of the at least one dyestuff is in general from 0.05 to 10% by weight, preferably 0.1 to 5% by weight, more preferably 0.2 to 3.5% by weight of the (dry) weight of the material. The material comprises preferably either at least one pigment or at least one dyestuff. Suitable pigments and dyestuffs are mentioned before.

### Process for Impregnation of the Material Forming the Meshed Fabric

Preferably, a process for impregnation of a material, for example a textile material or plastics material, comprises the steps of
i) forming an aqueous formulation or a melt, wherein an aqueous formulation is preferred, comprising at least one pesticide and at least one polymeric binder, preferably a polymeric binder as defined above, and optionally further ingredients;
ii) applying the aqueous formulation to the material by
   iia) passing the material through the aqueous formulation; or
   iib) bringing the material in contact with a roller that is partly or fully dipped into—the aqueous formulation and drawing the aqueous formulation to the side of the material in contact with the roller, or
   iic) double-side coating of the material, or
   iid) spraying the aqueous formulation onto the material, wherein the spraying is carried out with any suitable device for spraying by hand or automatically, for example with an aerosol can or devices usually used in a factory; or
   iie) applying the aqueous formulation in form of a foam; or
   iif) submerging the material into the aqueous formulation; or
   iig) brushing the aqueous formulation onto or into the material; or
   iih) pouring the aqueous formulation onto the material; or
   applying the melt by calendaring or with a doctor-blade;
iii) optionally removing surplus aqueous formulation or surplus melt (?); and
iv) drying and/or curing the material.

In the context of the invention, an aqueous formulation may be a solution, an emulsion or a suspension/dispersion.

The aqueous formulation or the melt preferably comprises the pesticidal composition, which is preferably employed in form of an aqueous formulation.

In the context of the invention “impregnation” is a process for applying the pesticidal composition. This process may include a process for curing the applied pestidical composition to achieve a coating onto the material, if desired. An “impregnated material” is a material onto which the pesticidal composition is applied. The “impregnated material” may be coated by curing the applied pesticidal composition, if desired.

The pesticidal composition may also be applied onto the material by transfer printing, inkjet printing, a screen process, and powder printing.

Details of the application of the pesticidal composition are well known to someone skilled in the art and are disclosed, e.g., in WO 2005/064072.

The method according to the invention is useful for protecting crop plants.

The method is useful for protecting the plant from any kind of pests and disease encountered in the cultivation of the plant.

Such pests include:

insects from the order of Lepidoptera, for example Agrotis ypsilon, Agrotis segetum, Alabama argillacea, Anticarsia gemmatalis, Argyresthia conjugella, Autographa gamma, Bupalus piniarius, Cacoecia murinana, Capua reticulana, Cheimatobia brumata, Choristoneura fumiferana, Choristoneura occidentalis, Cirphis unipuncta, Cydia pomonella, Dendrolimus pini, Diaphania nitidalis, Diatraea grandiosella, Earias insulana, Elasmopalpus lignosellus, Estigmene acrea, Eupoecilia ambiguella, Evetria bouliana, Feltia subterranea, Galleria mellonella, Grapholitha funebrana, Grapholitha molesta, Heliothis armigera, Heliothis virescens, Heliothis zea, Hellula undalis, Hibernia defoliaria, Hyphantria cunea, Hyponomeuta malinellus, Keiferia lycopersicella, Lambdina fiscellaria, Laphygma exigua, Leucoptera coffeella, Leucoptera scitella, Lithocolletis blancardella, Lobesia botrana, Loxostege sticticalis, Lymantria dispar, Lymantria monacha, Lyonetia clerkella, Malacosoma neustria, Mamestra brassicae, Orgyia pseudotsugata, Ostrinia nubilalis, Panolis flammea, Pectinophora gossypiella, Peridroma saucia, Phalera bucephala, Phthorimaea operculella, Phyllocnistis citrella, Pieris brassicae, Plathypena scabra, Plutella xylostella, Pseudoplusia includens, Rhyacionia frustrana, Scrobipalpula absoluta, Sitotroga cerealella, Sparganothis pilleriana, Spodoptera frugiperda, Spodoptera littoralis, Spodoptera litura, Thaumatopoea pityocampa, Tortrix viridana, Trichoplusia ni and Zeiraphera canadensis,

beetles (Coleoptera), for example Agrilus sinuatus, Agriotes lineatus, Agriotes obscurus, Amphimallus solstitialis, Anisandrus dispar, Anthonomus grandis, Anthonomus pomorum, Aphthona euphoridae, Athous haemorrhoidalis, Atomaria linearis, Blastophagus piniperda, Blitophaga undata, Bruchus rufimanus, Bruchus pisorum, Bruchus lentis, Byctiscus betulae, Cassida nebulosa, Cerotoma trifurcata, Cetonia aurata, Ceuthorrhynchus assimilis, Ceuthorrhynchus napi, Chaetocnema tibialis, Conoderus vespertinus, Crioceris asparagi, Ctenicera ssp., Diabrotica longicomis, Diabrotica semipunctata, Diabrotica 12-punctata Diabrotica speciosa, Diabrotica virgifera, Epilachna varivestis, Epitrix hirtipennis, Eutinobothrus brasiliensis, Hylobius abietis, Hypera brunneipennis, Hypera postica, Ips typographus, Lema bilineata, Lema melanopus, Leptinotarsa decemlineata, Limonius califomicus, Lissorhoptrus oryzophilus, Melanotus communis, Meligethes aeneus, Melolontha hippocastani, Melolontha melolontha, Oulema oryzae, Ortiorrhynchus sulcatus, Otiorrhynchus ovatus, Phaedon cochleariae, Phyllobius pyri, Phyllotreta chrysocephala, Phyllophaga sp., Phyllopertha horticola, Phyllotreta nemorum, Phyllotreta striolata, Popillia japonica, Sitona lineatus and Sitophilus granaria,

flies, mosquitoes (Diptera), e.g. Aedes aegypti, Aedes albopictus, Aedes vexans, Anastrepha ludens, Anopheles maculipennis, Anopheles crucians, Anopheles albimanus, Anopheles gambiae, Anopheles freeborni, Anopheles leucosphyrus, Anopheles minimus, Anopheles quadrimaculatus, Calliphora vicina, Ceratitis capitata, Chrysomya bezziana, Chrysomya hominivorax, Chrysomya macellaria, Chrysops discalis, Chrysops silacea, Chrysops atlanticus, Cochliomyia hominivorax, Contarinia sorghicola Cordylobia anthropophaga, Culicoides furens, Culex pipiens, Culex nigripalpus, Culex quinquefasciatus, Culex tarsalis, Culiseta inomata, Culiseta melanura, Dacus cucurbitae, Dacus oleae, Dasineura brassicae, Delia antique, Delia coarctata, Delia platura, Delia radicum, Dermatobia hominis, Fannia canicularis, Geomyza Tripunctata, Gasterophilus intestinalis, Glossina morsitans, Glossina palpalis, Glossina fuscipes, Glossina tachinoides, Haematobia irritans, Haplodiplosis equestris, Hippelates spp., Hylemyia platura, Hypoderma lineata, Leptoconops torrens, Liriomyza sativae, Liriomyza trifolii, Lucilia caprina, Lucilia cuprina, Lucilia sericata, Lycoria pectoralis, Mansonia titillanus, Mayetiola destructor, Musca domestica, Muscina stabulans, Oestrus ovis, Opomyza forum, Oscinella frit, Pegomya hysocyami, Phorbia antiqua, Phorbia brassicae, Phorbia coarctata, Phlebotomus argentipes, Psorophora columbiae, Psila rosae, Psorophora discolor, Prosimulium mixtum, Rhagoletis cerasi, Rhagoletis pomonella, Sarcophaga haemorrhoidalis, Sarcophaga sp., Simulium vittatum, Stomoxys calcitrans, Tabanus bovinus, Tabanus atratus, Tabanus lineola, and Tabanus similis, Tipula oleracea, and Tipula paludosa

thrips (Thysanoptera), e.g. Dichromothrips corbetti, Dichromothrips ssp, Frankliniella fusca, Frankliniella occidentalis, Frankliniella tritici, Scirtothrips citri, Thrips oryzae, Thrips palmi and Thrips tabaci,

termites (Isoptera), e.g. Calotermes flavicoffis, Leucotermes flavipes, Heterotermes aureus, Reticulitermes flavipes, Reticulitermes virginicus, Reticulitermes lucifugus, Termes natalensis, and Coptotermes formosanus,

cockroaches (Blattaria-Blattodea), e.g. Blattella germanica, Blattella asahinae, Periplaneta americana, Periplaneta japonica, Periplaneta brunnea, Periplaneta fuligginosa, Periplaneta australasiae, and Blatta orientalis;

true bugs (Hemiptera includine Homoptera), e.g. Acrosternum hilare, Blissus leucopterus, Cyrtopeltis notatus, Dysdercus cingulatus, Dysdercus intermedius, Eurygaster integriceps, Euschistus impictiventris, Leptoglossus phyllopus, Lygus lineolaris, Lygus pratensis, Nezara viridula, Piesma quadrata, Solubea insularis, Thyanta perditor, Acyrthosiphon onobrychis, Adelges laricis, Aphidula nasturtii, Aphis fabae, Aphis forbesi, Aphis pomi, Aphis gossypii, Aphis grossulariae, Aphis schneideri, Aphis spiraecola, Aphis sambuci, Acyrthosiphon pisum, Aulacorthum solani, Bemisia argentifoffi, Brachycaudus cardui, Brachycaudus helichrysi, Brachycaudus persicae, Brachycaudus prunicola, Brevicoryne brassicae, Capitophorus horni, Cerosipha gossypii, Chaetosiphon fragaefoffi, Cryptomyzus ribis, Dreyfusia nordmannianae, Dreyfusia piceae, Dysaphis radicola, Dysaulacorthum pseudosolani, Dysaphis plantaginea, Dysaphis pyri, Empoasca fabae, Hyalopterus pruni, Hyperomyzus lactucae, Macrosiphum avenae, Macrosiphum euphorbiae, Macrosiphon rosae, Megoura viciae, Melanaphis pyrarius, Metopolophium dirhodum, Myzus persicae, Myzus ascalonicus, Myzus cerasi, Myzus varians, Nasonovia ribis-nigri, Nilaparvata lugens, Pemphigus bursarius, Perkinsiella saccharicida, Phorodon humuli, Psylla mali, Psylla pini, Rhopalomyzus ascalonicus, Rhopalosiphum maidis, Rhopalosiphum path, Rhopalosiphum insertum, Sappaphis mala, Sappaphis mali, Schizaphis graminum, Schizoneura lanuginosa, Sitobion avenae, Trialeurodes vaporariorum, Toxoptera aurantiiand, Viteus vitifoffi, Cimex lectularius, Cimex hemipterus, Reduvius senilis, Triatoma spp., and Arilus critatus.

ants, bees, wasps, sawflies (Hymenoptera), e.g. Athalia rosae, Atta cephalotes, Atta capiguara, Atta cephalotes, Atta laevigata, Atta robusta, Atta sexdens, Atta texana, Crematogaster spp., Hoplocampa minuta, Hoplocampa testudinea, Monomorium pharaonis, Solenopsis geminata, Solenopsis invicta, Solenopsis richteri, Solenopsis xyloni, Pogonomyrmex barbatus, Pogonomyrmex califomicus, Pheidole megacephala, Dasymutilla occidentalis, Bombus spp. Vespula squamosa, Paravespula vulgaris, Paravespula pennsylvanica, Paravespula germanica, Dolichovespula maculata, Vespa crabro, Polistes rubiginosa, Camponotus floridanus, and Linepithema humile,

crickets, grasshoppers, locusts (Orthoptera), e.g. Acheta domestica, Gryllotalpa gryllotalpa, Locusta migratoria, Melanoplus bivittatus, Melanoplus femurrubrum, Melanoplus mexicanus, Melanoplus sanguinipes, Melanoplus spretus, Nomadacris septemfasciata, Schistocerca americana, Schistocerca gregaria, Dociostaurus maroccanus, Tachycines asynamorus, Oedaleus senegalensis, Zonozerus variegatus, Hieroglyphus daganensis, Kraussaria angulifera, Caffiptamus italicus, Chortoicetes terminifera, and Locustana pardalina,

Arachnoidea, such as arachnids (Acarina), e.g. of the families Argasidae, Ixodidae and Sarcoptidae, such as Amblyomma americanum, Amblyomma variegatum, Ambryomma maculatum, Argas persicus, Boophilus annulatus, Boophilus decoloratus, Boophilus microplus, Dermacentor silvarum, Dermacentor andersoni, Dermacentor variabilis, Hyalomma truncatum, Ixodes ricinus, Ixodes rubicundus, Ixodes scapularis, Ixodes holocyclus, Ixodes pacificus, Ornithodorus moubata, Ornithodorus hermsi, Ornithodorus turicata, Ornithonyssus bacoti, Otobius megnini, Dermanyssus gaffinae, Psoroptes ovis, Rhipicephalus sanguineus, Rhipicephalus appendiculatus, Rhipicephalus evertsi, Sarcoptes scabiei, and Eriophyidae spp. such as Aculus schlechtendali, Phyllocoptrata oleivora and Eriophyes sheldoni; Tarsonemidae spp. such as Phytonemus pallidus and Polyphagotarsonemus latus; Tenuipalpidae spp. such as Brevipalpus phoenicis; Tetranychidae spp. such as Tetranychus cinnabarinus, Tetranychus kanzawai, Tetranychus pacificus, Tetranychus telarius and Tetranychus urticae, Panonychus ulmi, Panonychus citri, and Oligonychus pratensis; Araneida, e.g. Latrodectus mactans, and Loxosceles reclusa,

fleas (Siphonaptera), e.g. Ctenocephalides felis, Ctenocephalides canis, Xenopsylla cheopis, Pulex irritans, Tunga penetrans, and Nosopsyllus fasciatus,

silverfish, firebrat (Thysanura), e.g. Lepisma saccharina and Thermobia domestica,

centipedes (Chilopoda), e.g. Scutigera coleoptrata,

millipedes (Diplopoda), e.g. Narceus spp.,

Earwigs (Dermaptera), e.g. forficula auricularia, and

lice (Phthiraptera), e.g. Pediculus humanus capitis, Pediculus humanus corporis, Pthirus pubis, Haematopinus eurysternus, Haematopinus suis, Linognathus vituli, Bovicola bovis, Menopon gaffinae, Menacanthus stramineus and Solenopotes capillatus,

nematodes such as Heterodera glycines, H. avenae, H. schachtii, H. trifolii, H. gottingiana, H. cajani, H. zeae, Globodera rostochiensis, G. paffida, G. tabacum, Meloidogyne arenaria, M. incognita, M. javanica, M. hapla, M. chitwoodi, Ditylenchus destructor, D. dipsaci, D. angustus, Anguina tritici, A. agrostis, Afrina/Anguina wevelli, Pratylenchus penetrans, P. brachyurus, P. coffeae, P. zeae, P. goodeyi, P. thornei, P. vulnus, Radopholus similis, Hirschmanniella oryzae, H. mucronata, H. spinicauda, Hoplolaimus columbus, H. seinhorsti, H. indicus, Rotylenchulus reniformis, Tylenchulus semipenetrans, Helicotylenchus multicinctus, H. multicinctus, H. mucronatus, H. dihystera, H. pseudorobustus, Criconemella C. xenoplax axestis, C. spharocephalum.

Further harmful fungi can be controlled.

Such fungi include those from the classes of the Ascomycetes, Deuteromycetes, Phycomycetes and Basidiomycetes. Specific examples include Alternaria species on fruit and vegetables, Botrytis cinerea (gray mold) on strawberries, vegetables, ornamental plants and grapevines, Cercospora arachidicola on peanuts, Erysiphe cichoracearum and Sphaerotheca fuliginea on cucurbits, Blumeria graminis (powdery mildew) on cereals, Fusarium and Verticillium species on various plants, Helminthosporium species on cereals, Mycosphaerella species on bananas and peanuts, Phytophthora infestans on potatoes and tomatoes, Plasmopara viticola on grapevines, Podosphaera leucotricha on apples, Pseudocercosporella herpotrichoides on wheat and barley, Pseudoperonospora species on hops and cucumbers, Puccinia species on cereals, Pyricularia oryzae on rice, Rhizoctonia species on cotton, rice and lawns, Septoria nodorum on wheat, Uncinula necator on grapevines, Ustilago species on cereals and sugar cane, and Venturia species (scab) on apples and pears.

The device according to the invention comprises a stabilizing structure and a meshed fabric as described above. It can be used to cover one or more plants to be protected for the entire time from seeding or planting to harvest or only for certain stages in the growth of these plants which may be particularly susceptible to attract certain pests.

The fabric is preferably a net, because this does not disturb the exchange of air, humidity and light between the plant and its environment—while it still affords good protection against pests.

Surprisingly, the use of nets leads to a good protection even in the case of fungal diseases.

The invention is further illustrated by the following examples without limiting it thereby.

### EXAMPLES

### Binder

### A) Preparation of Polymer Dispersions

### General Procedure:

250 g of water and 3 g of a styrene seed (33% by weight) having a medium particle diameter of 30 nm are heated to 85° C. and 5% by weight of feed 2 are added. After 10 min. addition of feed 1 comprising the monomers mentioned below and feed 2 is started.

Feed 2 comprises 3.0 g sodiumperoxidsulfate dissolved in 39.9 g of water.

The composition of feed 1 is listed in table 1.

Feed 1 and 2 are added in 3 h, and it was polymerized for further 0.5 h.

TABLE 1
Composition of feed 1 in % by weight pphm (parts per hundred monomers)

| Monomer | | | | | | | | | | | | | | BMA- |
|---|---|---|---|---|---|---|---|---|---|---|---|---|---|---|
| compositions | MMA | S | AN | EHA | BA | EA | HPMA | GMA | MaMol | AMol | AM | AS | FI-1 | Acac |
| A 1 | 27.0 | | | 3.1 | 65.0 | | | | | | 2.0 | 1.0 | 1.9 | |
| A 2 | 23.9 | 5.0 | | 5.3 | 60.0 | | | | | | 1.2 | 0.6 | | 4.0 |
| A 3 | | 16.6 | | 30.0 | 30.0 | 20.0 | | | | 3.0 | | 0.4 | | |
| A 4 | 25.7 | 5.0 | | 5.3 | 60.0 | | | | 3.5 | | | 0.5 | | |
| A 5 | | 14.7 | 11.0 | | 70.0 | | | | 3.5 | | 0.5 | 0.3 | | |
| A 6 | 30.0 | 13.0 | 8.0 | | 45.2 | | | | | 3.0 | 0.5 | 0.3 | | |
| A 7 | 30.0 | 13.0 | 8.0 | | 44.5 | | | | | | 0.5 | 0.3 | | 3.7 |
| A 8 | 33.0 | | | | 60.0 | 3.9 | | | | | 1.0 | 0.5 | 1.6 | |
| A 9 | 20.0 | 20.0 | | 17.0 | 23.0 | 15.3 | | | 3.5 | | | 1.2 | | |
| A 10 | 20.0 | 20.0 | | 17.0 | 23.0 | 15.3 | | | | | 0.4 | 0.3 | | 4.0 |
| A 11 | 10.0 | 10.0 | | | 25.5 | 50.0 | 2.5 | | | | | 2.0 | | |
| A 12 | 10.0 | 10.0 | | | 25.5 | 47.7 | 2.5 | 3.5 | | | 0.7 | 0.1 | | |
| A 13 | | 10.0 | 11.0 | | 60.0 | 14.7 | | 4.0 | | | 0.2 | 0.1 | | |
| A 14 | | 20.0 | 8.0 | | 55.0 | 12.5 | 3.0 | | | | | 1.5 | | |
| A 15 | 26.0 | | 13.0 | | 57.0 | | | | 3.0 | | | 1.0 | | |
| A 16 | 15.0 | | 13.0 | | 68.0 | | | | 3.0 | | | 1.0 | | |
| A 17 | | | 16.0 | | 81.0 | | | | 2.0 | | | 1.0 | | |

The amount of initiator sodium peroxidisulfate is 0.3 parts by weight, the emulsifier comprises 0.4 parts by weight of Dowfax 2A1 (Dow) and 0.6 parts by weight of Lumiten IRA (BASF AG), relating to 100 parts by weight of the monomer composition of table 1.

### Abbreviations:

MMA: methyl methacrylate
S: styrene
AN: acrylic nitril
EA: ethyl acrylate
EHA: 2-ethylhexylacrylate
BA: n-butyl acrylate
FI: copolymerizable benzophenone having an acrylic group
GMA: glycidylmethacrylate
BMA-Acac: bitandiolmonoacrylate acetylacetate
Amol: N-methylol acrylamide
MAMoI: N-methylol methacrylamide
HPMA: hydroxypropyl methacrylate
AS: acrylic acid
AM: acrylic amide

### Dowfax 2A1:

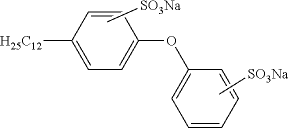

### Lumiten IRA:

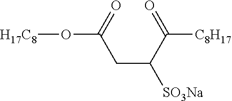

### Examples A1 and A8

Aqueous polymer dispersions comprising FI-1 polymerizable photo initiator which is later useful as crosslinking agent is a photo initiator of formula

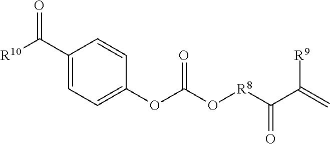

wherein
R⁸ is an organic radical having from 1 to 30 carbon atoms,
R⁹ is H or a methyl group, and
R¹⁰ is a phenyl group which is optionally substituted or a C₁- to C₄-alkyl group.

### Examples of Use

The insecticidal treatment is performed with aqueous dispersions according to example A17 on commercially available white polyester netting material (fiber titer 75 denier, 156 mesh, weight 28-32 g/m²) without prior washing. The aqueous treatment baths are prepared by mixing the aqueous dispersions with commercially available emulsions of insecticide and/or repellent, setting pH with buffer solutions and adding a fixative (if needed). The concentrations of the treatment baths were adjusted according to the liquor uptake possible (LU between 60 and 100%). The treatment baths are applied by using a padder-stenter equipment on a laboratory scale (Mathis AG, Switzerland). The netting material is fully immersed into the treatment bath and excess liquor is removed by passing it through cylinders which move in counter-direction. By choosing a defined distance between these cylinders (and thus a defined pressure) the liquor uptake can be controlled. The liquor uptake is measured by weighing an impregnated piece of netting and subtracting the weight of the dry, untreated netting and is given as % weight of liquor on weight of netting. The drying/curing step is performed in a laboratory stenter which allows to control the temperature and time of the treatment.

For treating insects in laboratory bio-assays insecticidal-impregnated long-lasting insecticidal nets (LLIN, @ 200 mg ai/m2) are cut to fit into Petri dishes. Nets are placed on the bottom of the dishes and 10 insects are introduced into each dish on the nets. Mortality/moribundity is evaluated at several minutes, hours and possibly days after exposure. The number of replications is determined on the number of treatments tested.

For field trials several methods are available depending on the type of crop. Methods a) to e) are typical examples:

a) Long lasting insecticidal nets as described above are loosely placed directly on plant beds of cabbage and are secured against being removed by wind. The plant can be freely reached by light, air and water. The net is raised by the emergence and growth of the plants, but does not restrict growth.

Infestation by typical pests is recorded until harvesting and compared with the values for plants grown in unprotected beds and plants grown under untreated nets.

b) Long lasting insecticidal nets as described above are placed over poles used for growing tomato plants, in a way that the whole plants are covered by the nets. The tomato plants can be freely reached by light, air and water.

Infestation by typical pests is recorded until harvesting and compared with the values for plants grown without protection and with protection from untreated nets.

c) Long lasting insecticidal nets as described above are placed on a wooden supporting frame covering plant beds where strawberry plants are grown. The plants can be freely reached by light, air and water.

Infestation by typical pests is recorded until harvesting and compared with the values for plants grown without protection and with protection from untreated nets.

d) Tobacco plants in a tobacco nursery are placed under a wire frame covered with a long lasting insecticidal net as described above. The plants can be freely reached by light, air and water.

Infestation by typical pests is recorded and compared with the values for plants grown without protection from untreated nets.

e) Long lasting insecticidal nets as described above are placed over apple trees shortly before blossoming. The trees can be freely reached by light, air and water.

Infestation by typical pests is recorded until harvesting and compared with the values for plants grown without protection and with protection from untreated nets.

What is claimed:

1. A method for protecting crop plants from pests and diseases, comprising the step of covering one or more of the plants with a device, comprising a stabilizing structure and a meshed fabric, where the meshed fabric is impregnated with a pesticide and is penetrable by light, air and water,
wherein the material forming the meshed fabric is treated with a composition comprising:
a. at least one pesticide (component A), and
b. at least one polymeric binder (component B),
and wherein the polymeric binder (B) is selected from the group consisting of polyacrylates, polymethacrylates, polyacrylonitrile, polymaleic acid anhydride, polymaleic acid, polymaleic acid esters, and polymaleic acid amides, polystyrene, poly(methyl)styrene, polybutadiene, polyvinylacetate, polyvinylalcohol, copolymers obtained by polymerization of at least two different ethylenically unsaturated monomers of the group of monomers mentioned above and blends of said homopolymers and/or copolymers, poly(styrene-acrylates), poly(styrene-butadiene), ethylene-acrylate-copolymers, ethylene-vinylacetate-copolymers, which may be partially or completely hydrolyzed, polyurethanes and/or or polyisocyanurates, blends comprising polyurethanes and/or polyisocyanurates, blends comprising polyurethanes and/or polyisocyanurates and polycarbonates; mineral waxes, zirconium waxes, silicones, polysiloxanes, fluorinated polyacrylates and methacrylates, fluorosilicones, and fluorocarbon resins, melamine formaldehyde condensation resins, methylol urea derivatives; curable polyesters;
and
blends or preparations comprising at least one of said polymeric binders;
and where the stabilizing structure comprises one or more poles, one or more clamp like structures or a framework to which the mesh material is allocated in order to form a closed interior.

2. The method as claimed in claim 1, wherein the material forming the meshed fabric is a synthetic or natural textile material, plastic material, a leather material, a flocked fabric, a sheeting, foil, a packaging material or a cellulose containing material.

3. The method as claimed in claim 1, wherein the material is a netting.

4. The method as claimed in claim 1, wherein the composition comprises (based on the total content of components A and B), 0.001 to 95 wt.-% of at least one pesticide, and 5 to 99.999 wt.-% of at least one polymeric binder.

5. The method as claimed in claim 1, wherein the pesticide is selected from insecticides from the group consisting of pyrethroid compounds, carbamate compounds, organophosphorous compounds, sterilising compounds, nicotinic acetylcholine receptor antagonists, chlorine channel activators, juvenile hormone mimics, selective feeding blockers, mite growth inhibitors, microbial insecticides, inhibitors of oxidative phophorylation, uncouplers of oxidative phosphorylation, inhibitors of chitin biosynthesis, Ecdyson agonists and molting disruptors, Octopamine ergic agonists, coupling site II electron transport inhibitors, coupling site I electron transport inhibitors, voltage dependent sodium channel blockers, inhibitors of lipid biosynthesis, neuronal inhibitors, Aconitase inhibitors, N-arylhydrazine derivatives, synergists, Ryanodine receptor modulators, benzoximate, chinomethionat, dicofol, pyridalyl, borax, and tartar emetic; repellents, molluscicides, rodenticides, and fungicides.

6. The method as claimed in claim 1, wherein the polymeric binder is an acrylic binder, obtained by radical polymerization of at least one monomer of formula II 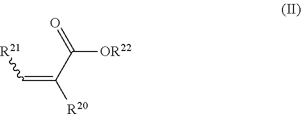
wherein
R²⁰, R²¹ and R²² are independently selected from C₁- to C₁₀-alkyl, which is optionally fluoro substituted and which may be linear or branched, or
R²⁰ and R²¹ may further be H.

7. The method as claimed in claim 6, wherein the C₁- to C₁₀-alkyl comprises methyl, ethyl, n-propyl, i-propyl, n-butyl, i-butyl, sec-butyl, t-butyl, n-pentyl, i-pentyl, sec-pentyl, neo-pentyl, 1,2-dimethylpropyl, i-amyl, n-hexyl, i-hexyl, sec-hexyl, n-heptyl, n-octyl, 2-ethylhexyl, n-nonyl, n-decyl; substituted or unsubstituted aryl, substituted or unsubstituted C₆- to C₁₀-aryl, substituted or unsubstituted C₆-aryl, phenyl, or tolyl.

8. A device for protecting plants from pests and diseases comprising a stabilizing structure and a meshed fabric, wherein the meshed fabric is impregnated with a pesticide and is penetrable by light, air and water, wherein the material forming the meshed fabric is treated with a composition comprising:
a. at least one pesticide (component A), and
b. at least one polymeric binder (component B),
and where the polymeric binder (B) is selected from the group consisting of polyacrylates, polymethacrylates, polyacrylonitrile, polymaleic acid anhydride, polymaleic acid, polymaleic acid esters, and polymaleic acid amides, polystyrene, poly(methyl)styrene, polybutadiene, polyvinylacetate, polyvinylalcohol, copolymers obtained by polymerization of at least two different ethylenically unsaturated monomers of the group of monomers mentioned above and blends of said homopolymers and/or copolymers, poly(styrene-acrylates), poly(styrene-butadiene), ethylene-acrylate-copolymers, ethylene-vinylacetate-copolymers, which may be partially or completely hydrolyzed, polyurethanes and/or or polyisocyanurates, blends comprising polyurethanes and/or polyisocyanurates, blends comprising polyurethanes and/or polyisocyanurates and polycarbonates; mineral waxes, zirconium waxes, silicones, polysiloxanes, fluorinated polyacrylates and methacrylates, fluorosilicones, and fluorocarbon resins, melamine formaldehyde condensation resins, methylol urea derivatives; and curable polyesters
and
blends or preparations comprising at least one of said polymeric binders;
and where the stabilizing structure comprises one or more poles, one or more clamp like structures or a framework to which the mesh material is allocated in order to form a closed interior.
